(19) United States
(12) Patent Application Publication
(10) Pub. No.: US 2025/0296194 A1
(43) Pub. Date: Sep. 25, 2025

(54) DIE GRINDER

(71) Applicant: MAKITA CORPORATION, Anjo-shi (JP)

(72) Inventors: Makoto CHIKARAISHI, Anjo-shi (JP); Hiroki Kaneko, Anjo-shi (JP)

(73) Assignee: MAKITA CORPORATION, Anjo-shi (JP)

(21) Appl. No.: 19/063,573

(22) Filed: Feb. 26, 2025

(30) Foreign Application Priority Data
Mar. 21, 2024 (JP) 2024-04580

(51) Int. Cl. B24B 23/02

(52) U.S. Cl. CPC B24B 23/028

(57) ABSTRACT

A die grinder includes: a motor; a spindle that is rotationally driven around a drive axis that defines a front-rear direction of the die grinder; a housing; and at least two light emitting parts that are assembled on a front surface of a circuit substrate. In directions orthogonal to the drive axis, a direction toward the drive axis from a cross-sectional center of a grip part is defined as a downward direction. When the front surface is divided into four quadrants by a line passing the drive axis in an up-down direction and a line passing the drive axis in a left-right direction orthogonal to the up-down direction, the at least two light emitting parts include at least first and second light emitting parts that are respectively arranged in the upper right quadrant and the upper left quadrant of the four quadrants relative to the drive axis.

### CROSS-REFERENCE TO RELATED APPLICATION

This application claims priority to Japanese patent application no. 2024-044580 filed on Mar. 21, 2024, the contents of which are fully incorporated herein by reference.

### TECHNICAL FIELD

The present disclosure relates to a die grinder.

### BACKGROUND

A die grinder is known that performs an operation such as grinding and polishing by rotating a spindle with rotational power generated by a motor used as a driving source and thus rotating around a drive axis a tool accessory such as a grinding stone mounted to a front end of the spindle (as disclosed, for example, in Japanese Unexamined Patent Application Publication No. 2011-045953).

### SUMMARY

In grinding or other operations using a die grinder, a workpiece can be placed in a direction crossing the drive axis relative to the tool accessory. It is therefore desired to provide a technique for improving visibility of a workpiece placed in a direction crossing the drive axis.

The present disclosure can be realized as the following aspects.

According to a first aspect of the present disclosure, a die grinder is provided. The die grinder includes a motor, a spindle, a housing and at least two light emitting parts. The motor is driven by electric power. The spindle is rotationally driven by power of the motor around a drive axis that defines a front-rear direction of the die grinder. The housing includes a motor housing, a handle housing and a tool housing. The motor housing houses the motor. The handle housing is connected to a rear end of the motor housing and includes a grip part configured to be held by a user. In the tool housing, the spindle and a circuit substrate are disposed. The at least two light emitting parts are assembled on a front surface of the circuit substrate. In directions orthogonal to the drive axis, a direction toward the drive axis from a cross-sectional center of the grip part is defined as a downward direction. When the front surface is divided into four quadrants by a line passing the drive axis in an up-down direction and a line passing the drive axis in a left-right direction orthogonal to the up-down direction, the at least two light emitting parts include at least first and second light emitting parts that are respectively arranged in the upper right quadrant and the upper left quadrant of the four quadrants relative to the drive axis.

According to this aspect, the die grinder improves the visibility of a workpiece placed below the die grinder.

According to a second aspect of the present disclosure, a die grinder is provided. The die grinder includes a motor, a spindle, a housing, at least two light emitting parts and a battery mounting part. The motor is driven by electric power supplied from a battery. The spindle is rotationally driven by power of the motor around a drive axis that defines a front-rear direction of the die grinder. The housing includes a motor housing, a handle housing and a tool housing. The motor housing houses the motor. The handle housing is connected to a rear end of the motor housing and includes a grip part configured to be held by a user. In the tool housing, the spindle and a circuit substrate are disposed. The at least two light emitting parts are assembled on a front surface of the circuit substrate. The battery mounting part is configured such that the battery is removably mounted along a mounting/removing direction crossing the drive axis. The handle housing includes a handle recess that is formed by an outer surface of the handle housing being recessed relative to an outer surface of the motor housing. A direction toward the handle recess from the drive axis along the mounting/removing direction is defined as a downward direction. When the front surface is divided into four quadrants by a line passing the drive axis in an up-down direction and a line passing the drive axis in a left-right direction orthogonal to the up-down direction, the at least two light emitting parts include at least first and second light emitting parts that are respectively arranged in the upper right quadrant and the upper left quadrant of the four quadrants relative to the drive axis.

According to this aspect, the die grinder improves the visibility of a workpiece placed below the die grinder.

According to a third aspect of the present disclosure, a die grinder is provided. The die grinder includes a motor, a spindle, a housing and at least two light emitting parts. The motor is driven by electric power. The spindle is rotationally driven by power of the motor around a drive axis that defines a front-rear direction of the die grinder. The housing includes a motor housing, a handle housing and a tool housing. The motor housing houses the motor. The handle housing is connected to a rear end of the motor housing and includes a grip part configured to be held by a user. In the tool housing, the spindle and a circuit substrate are disposed. The at least two light emitting parts are assembled on a front surface of the circuit substrate. A part of the grip part that has a maximum curvature on an outer contour in a cross section that is orthogonal to the drive axis is defined as an end part, and a direction toward the end part from a cross-sectional center of the grip part or the drive axis is defined as a downward direction. When the front surface is divided into four quadrants by a line passing the drive axis in an up-down direction and a line passing the drive axis in a left-right direction orthogonal to the up-down direction, the at least two light emitting parts include at least first and second light emitting parts that are respectively arranged in the upper right quadrant and the upper left quadrant of the four quadrants relative to the drive axis.

According to this aspect, the die grinder improves the visibility of a workpiece placed below the die grinder.

According to a fourth aspect of the present disclosure, a die grinder is provided. The die grinder includes a motor, a spindle, a housing, at least two light emitting parts and an operation part. The motor is driven by electric power. The spindle is rotationally driven by power of the motor around a drive axis that defines a front-rear direction of the die grinder. The housing includes a motor housing, a handle housing and a tool housing. The motor housing houses the motor. The handle housing is connected to a rear end of the motor housing and includes a grip part configured to be held by a user. In the tool housing, the spindle and a circuit substrate are disposed. The at least two light emitting parts are assembled on a front surface of the circuit substrate. The operation part is provided on the housing for on-off operation of the motor. In directions orthogonal to the drive axis, a direction toward the operation part from a cross-sectional center of the grip part or the drive axis is defined as an upward direction. When the front surface is divided into four quadrants by a line passing the drive axis in an up-down direction and a line passing the drive axis in a left-right direction orthogonal to the up-down direction, the at least two light emitting parts include at least first and second light emitting parts that are respectively arranged in the upper right quadrant and the upper left quadrant of the four quadrants relative to the drive axis.

According to this aspect, the die grinder improves the visibility of a workpiece placed below the die grinder.

According to a fifth aspect of the present disclosure, a die grinder is provided. The die grinder includes a motor, a spindle, a housing, at least two light emitting parts and an operation part. The motor is driven by electric power. The spindle is rotationally driven by power of the motor around a drive axis that defines a front-rear direction of the die grinder. The housing includes a motor housing, a handle housing and a tool housing. The motor housing houses the motor. The handle housing is connected to a rear end of the motor housing and includes a grip part configured to be held by a user. In the tool housing, the spindle and a circuit substrate are disposed. The at least two light emitting parts are assembled on a front surface of the circuit substrate. The operation part is provided on the housing for on-off operation of the motor. In directions orthogonal to the drive axis, a direction toward the operation part from a cross-sectional center of the grip part or the drive axis is defined as a rightward or leftward direction. When the front surface is divided into four quadrants by a line passing the drive axis in an up-down direction orthogonal to a left-right direction and a line passing the drive axis in a left-right direction, the at least two light emitting parts include at least first and second light emitting parts that are respectively arranged in the upper right quadrant and the upper left quadrant of the four quadrants relative to the drive axis.

According to this aspect, the die grinder improves the visibility of a workpiece placed below the die grinder.

According to a sixth aspect of the present disclosure, a die grinder is provided. The die grinder includes a motor, a spindle, a housing, at least two light emitting parts and a paddle switch. The motor is driven by electric power. The spindle is rotationally driven by power of the motor around a drive axis that defines a front-rear direction of the die grinder. The housing includes a motor housing, a handle housing and a tool housing. The motor housing houses the motor. The handle housing is connected to a rear end of the motor housing and includes a grip part configured to be held by a user. In the tool housing, the spindle and a circuit substrate are disposed. The at least two light emitting parts are assembled on a front surface of the circuit substrate. The paddle switch is provided on the grip part for on-off operation of the motor. In directions orthogonal to the drive axis, a direction toward the paddle switch from a cross-sectional center of the grip part is defined as a downward direction. When the front surface is divided into four quadrants by a line passing the drive axis in an up-down direction and a line passing the drive axis in a left-right direction orthogonal to the up-down direction, the at least two light emitting parts include at least first and second light emitting parts that are respectively arranged in the upper right quadrant and the upper left quadrant of the four quadrants relative to the drive axis.

According to this aspect, the die grinder improves the visibility of a workpiece placed below the die grinder.

### BRIEF DESCRIPTION OF THE DRAWINGS

FIG. 1 is a perspective view for showing the structure of a die grinder according to a first embodiment of the present disclosure.

FIG. 2 is a side view of the die grinder of the first embodiment.

FIG. 3 is a cross-sectional view of positions III-III shown in FIG. 2.

FIG. 4 is a cross-sectional view of positions IV-IV shown in FIG. 1.

FIG. 5 is an explanatory view for showing the structure of elements disposed within a tool housing.

FIG. 6 is an exploded perspective view of an illumination device.

FIG. 7 is a front view showing a front surface of a circuit substrate.

FIG. 8 is a cross-sectional view of positions VIII-VIII shown in FIG. 7.

FIG. 9 is a cross-sectional view of positions IX-IX shown in FIG. 7.

FIG. 10 is a front view for showing the arrangement of light emitting parts in a comparative example.

FIG. 11 is a cross-sectional view of positions XI-XI shown in FIG. 10.

FIG. 12 is a cross-sectional view of positions XII-XII shown in FIG. 10.

FIG. 13 is an explanatory view for showing a simulation result of the illuminance distribution of light irradiated downward by the illumination device.

FIG. 14 is an explanatory view for showing a simulation result of the appearance of light irradiated by the illumination device.

FIG. 15 is an explanatory view for showing a simulation result of the illuminance distribution of light irradiated downward by an illumination device of a comparative example.

FIG. 16 is an explanatory view for showing a simulation result of the appearance of light irradiated by the illumination device of the comparative example.

FIG. 17 is a front view for showing the arrangement of light emitting parts in a second comparative example.

FIG. 18 is a cross-sectional view of positions XVIII-XVIII shown in FIG. 17.

FIG. 19 is a cross-sectional view of positions XIX-XIX shown in FIG. 17.

FIG. 20 is an explanatory view for showing a simulation result of the illuminance distribution of light irradiated downward by an illumination device of the second comparative example.

FIG. 21 is an explanatory view for showing a simulation result of the appearance of light irradiated by the illumination device of the second comparative example.

FIG. 22 is an explanatory view for showing the structure of a lower side of a barrel.

FIG. 23 is an explanatory view for showing the configuration of an inner peripheral surface of the tool housing.

FIG. 24 is an explanatory view for showing the internal structure of a lower part of a motor housing.

FIG. 25 is a second explanatory view for showing the internal structure of the lower part of a motor housing.

FIG. 26 is a first explanatory view for showing a method of defining directions according to another embodiment.

FIG. 27 is a second explanatory view for showing a method of defining directions according to another embodiment.

FIG. 28 is a third explanatory view for showing a method of defining directions according to another embodiment.

FIG. 29 is a fourth explanatory view for showing a method of defining directions according to another embodiment.

FIG. 30 is a fifth explanatory view for showing a method of defining directions according to another embodiment.

FIG. 31 is a sixth explanatory view for showing a method of defining directions according to another embodiment.

FIG. 32 is an explanatory view for showing the arrangement position of the light emitting parts according to another embodiment.

### DETAILED DESCRIPTION OF THE EMBODIMENTS

Representative, non-limiting examples of the present invention are described in detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved tools and manufacturing and using methods of the tools.

Moreover, combinations of features and steps disclosed within the following detailed description may not be necessary to practice the invention in the broadest sense, and are instead taught merely to particularly describe representative examples of the invention. Furthermore, various features of the representative examples described above and below, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In at least one non-limiting embodiment according to the present disclosure, the at least two light emitting parts may further include a third light emitting part that is arranged right below the drive axis on the front surface.

According to this embodiment, arrangement of the light emitting parts right below the drive axis in the die grinder improves illuminance of a workpiece placed below the die grinder, while suppressing upward light irradiation of the light emitting parts.

In addition or in the alternative to the preceding embodiment, the front surface may have an annular shape. The at least two light emitting parts may be arranged on the front surface in a region inside of an intermediate circle, which is a circle formed along an intermediate position between two peripheries, which includes an outer periphery and an inner periphery closer to the drive axis.

According to this embodiment, the die grinder can irradiate light in a wider range onto a workpiece, compared with a structure in which the light emitting parts are arranged in the outer region outside of the intermediate circle.

In addition or in the alternative to the preceding embodiments, the die grinder may further have a protection member that is provided in front of the at least two light emitting parts and transmits light of the at least two light emitting parts. The protection member may have a body part that covers the at least two light emitting parts, a base part that extends rearward from the body part, and claws that are formed on an extending end of the base part and configured to be engaged with a recess that is formed in a member arranged rearward of the circuit substrate.

According to this embodiment, provision of the snap fit structure facilitates mounting and removal of the illumination device, which facilitates repair of the illumination device.

In addition or in the alternative to the preceding embodiments, the die grinder may further have a spindle bearing that rotatably supports the spindle; a barrel that houses the spindle bearing; and a bearing retainer that is arranged in front of the spindle bearing and fixed to a front end part of the barrel. The recess may be formed in an outer surface of the bearing retainer. The circuit substrate and the at least two light emitting parts may be held between the protection member and the bearing retainer with the claws and the recess engaged with each other.

According to this embodiment, in the die grinder, increase in size of the protection member in the radial direction can be reduced, compared with a structure in which the protection member is engaged with an outer peripheral surface of the barrel.

In addition or in the alternative to the preceding embodiments, the die grinder may further have a barrel that houses at least part of the spindle. The barrel may have first and second wall parts protruding from an outer surface of the barrel. An electric wire connected to the circuit substrate may be arranged in a barrel wire path that is defined by the first and second wall parts.

According to this embodiment, in the die grinder, by provision of the first and second wall parts, a wiring path of the wire is formed around the barrel while the barrel is reinforced.

In addition or in the alternative to the preceding embodiments, a first protrusion may be formed on a surface of the first wall part facing the second wall part and protrude toward the second wall part. A second protrusion may be formed on a surface of the second wall part facing the first wall part and protrude toward the first wall part.

According to this embodiment, in the die grinder, the wire is restrained or restricted from coming off from the barrel wire path.

In addition or in the alternative to the preceding embodiments, a recess may be formed in an inner surface of the tool housing to receive the first and second wall parts.

According to this embodiment, the tool housing is easy to hold, so that the die grinder is provided with high operability.

In addition or in the alternative to the preceding embodiments, the motor housing may include an outer wall part and a support wall part that supports the motor within the motor housing. A motor wire path for passing the wire may be provided between the support wall part and the outer wall within the motor housing.

According to this embodiment, in the die grinder, the wire is restrained from coming into contact with elements disposed within the motor housing.

In addition or in the alternative to the preceding embodiments, the die grinder may further have a fan for cooling the motor; a motor bearing that is disposed between the motor and the spindle within the housing and rotatably supports a motor shaft of the motor; and a motor bearing retainer that supports the motor bearing. The motor bearing retainer may have an opening through which air flow from the fan passes. The barrel wire path, the opening and the motor wire path may be configured to communicate with each other.

According to this embodiment, in the die grinder, increase in size of the motor housing in the radial direction can be reduced or restricted by utilizing the opening as a wiring path of the wire, compared with a structure in which the wiring path is formed to bypass the motor bearing retainer.

In addition or in the alternative to the preceding embodiments, the die grinder may further have a controller that is configured to control operations of the die grinder. The controller may be arranged such that the drive axis passes therethrough.

According to this embodiment, the die grinder can be reduced in size in the radial direction.

In addition or in the alternative to the preceding embodiments, the motor may have a motor shaft that rotates around a motor rotation axis. The motor rotation axis may be coincident with the drive axis.

According to this embodiment, the die grinder can be reduced in size in the radial direction.

In addition or in the alternative to the preceding embodiments, the die grinder may further have a battery for supplying power to the motor, and a battery mounting part configured such that the battery is removably mounted thereto.

### A. FIRST EMBODIMENT

### A1. The Structure of Outer Elements of a Die Grinder 100:

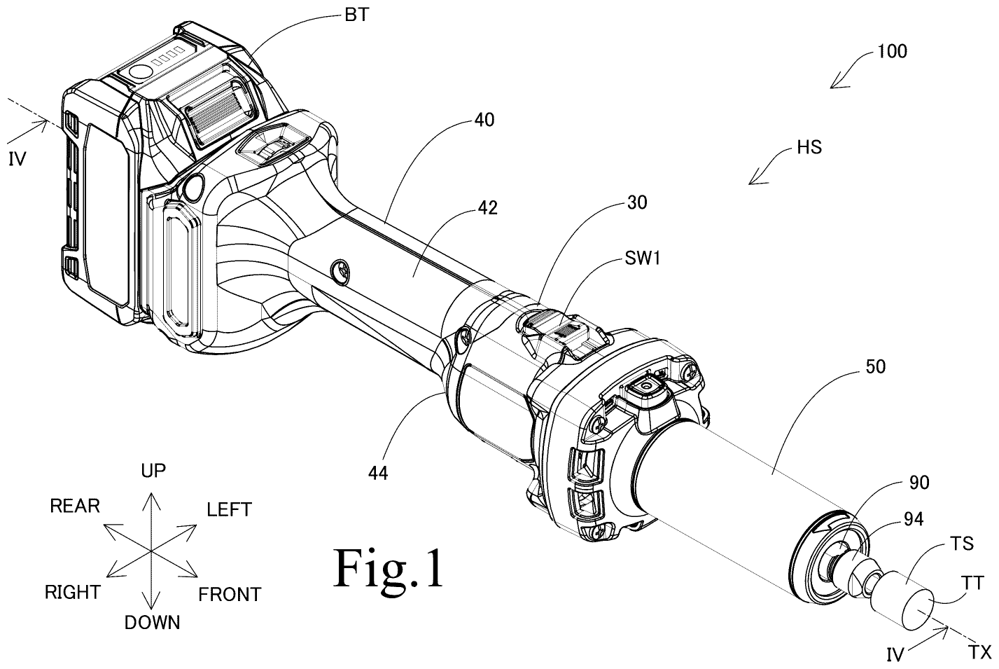

A die grinder 100 according to a first embodiment of the present disclosure is now described with reference to FIG. 1. The die grinder 100 is a representative example of a power tool according to the present disclosure, having the whole length of approximately 400 mm in a front-rear direction. The die grinder 100 rotates a spindle 90 around a drive axis TX with rotational power generated by driving a motor 20 described below. A tool accessory TT is mounted to a front end of a spindle 90 and rotated by rotation of the spindle 90. In the example shown in FIG. 1, the tool accessory TT includes a generally cylindrical grinding stone with a shank, having a side face TS that functions as a grinding face. A user can perform an operation such as grinding and polishing by operating the die grinder 100 to rotate the tool accessory TT while pressing the side face TS onto a workpiece.

The shape of the tool accessory TT is not limited to a cylindrical shape, and it may be appropriately changed to other various shapes, such as a pyramid shape including a cone shape, according to a workpiece. Further, the tool accessory TT is not limited to a grinding stone, and it may be other tool accessories such as a flap wheel with sanding paper adhered thereon. The die grinder 100 is also referred to as a hand grinder or a straight grinder.

In the following description, for the sake of convenience of explanation, the extending direction of the drive axis TX is defined as a front-rear direction of the die grinder 100. In the front-rear direction, an end part side of a housing HS on which the spindle 90 is disposed is defined as a front side of the die grinder 100, and the opposite side is defined as a rear side of the die grinder 100. Definitions of an up-down direction and a left-right direction will be made below.

The die grinder 100 has a generally cylindrical housing HS extending in the front-rear direction. The housing HS includes a motor housing 30, a handle housing 40 and a tool housing 50. A motor 20 is housed in the motor housing 30.

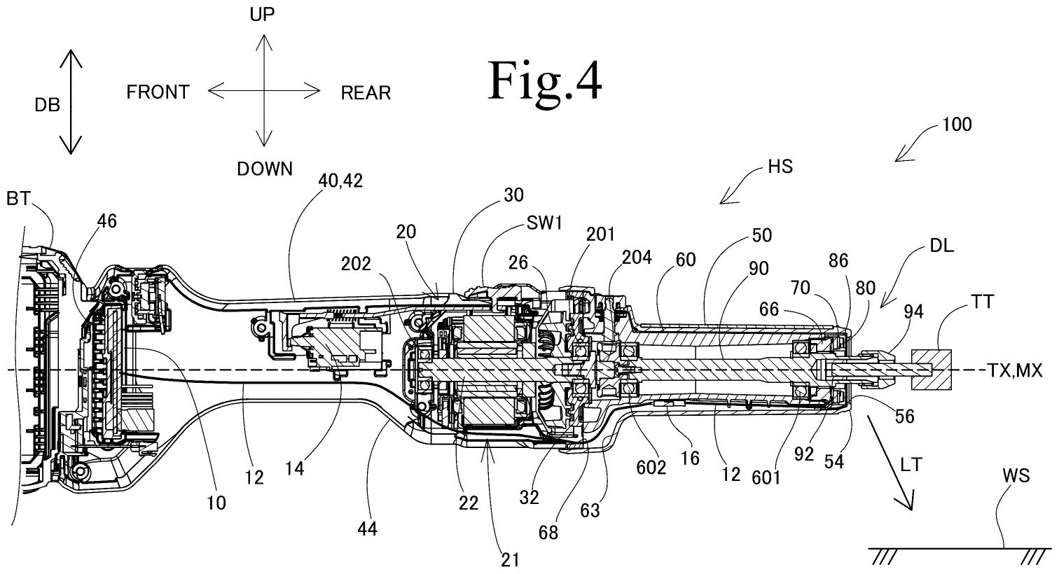

The handle housing 40 is connected to a rear end of the motor housing 30. The handle housing 40 includes a grip part 42, a handle recess 44 and a battery mounting part 46 (see FIG. 4) for a battery BT.

The grip part 42 is configured to be held by a user. The grip part 42 is formed to have a sectional width smaller than the sectional width of the motor housing 30 so as to have the sectional width and shape easy to hold. In this embodiment, the grip part 42 is covered with an insulating material such as elastomer.

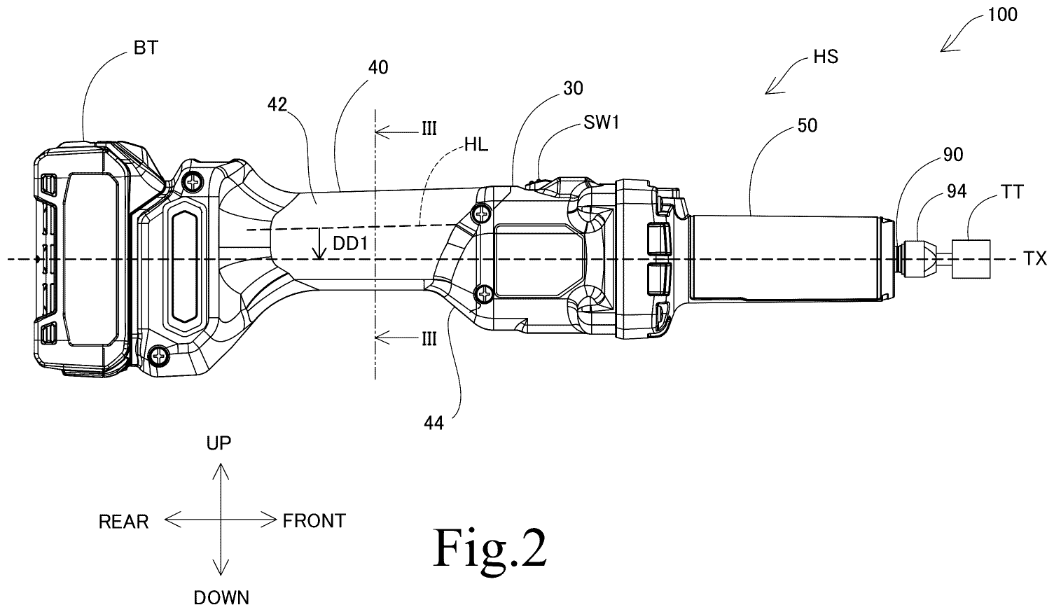

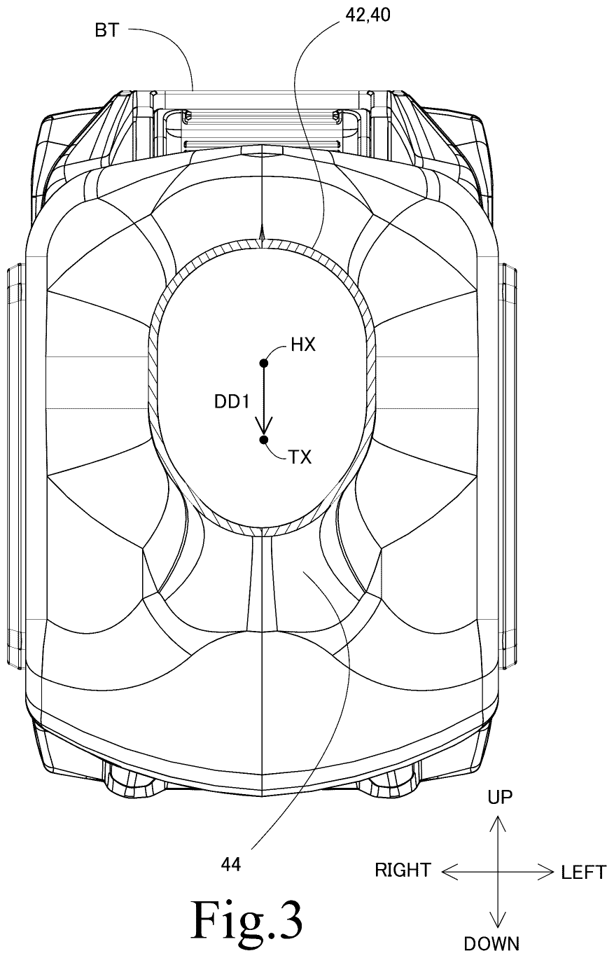

In FIGS. 2 and 3, a cross-sectional center HX of the grip part 42, which is a centroid of an outer contour HF in a cross-section, that is orthogonal to the drive axis, of the grip part 42 as shown in FIG. 3, is shown. The cross-sectional center HX of the grip part 42 may be defined by the position of the center of gravity in the cross section of the grip part 42. In the die grinder 100 of this embodiment, a direction orthogonal to the drive axis TX is defined as an up-down direction. In the up-down direction, a direction DD1 toward the drive axis TX from the cross-sectional center HX of the grip part 42 is defined as a downward direction, and the opposite direction is defined as an upward direction. A direction orthogonal to the front-rear direction and the up-down direction is defined as a left-right direction. The downward direction can be an appropriate direction to move the die grinder 100 toward a workpiece when processing the workpiece using die grinder 100.

A line HL shown in FIG. 2 indicates the position of the cross-sectional center HX in the front-rear direction of the grip part 42. The line HL is, for example, a regression line derived by the least-squares method using a plurality of cross-sectional centers HX in the front-rear direction. As shown in FIG. 2, in the die grinder 100 of this embodiment, the line HL is located above the drive axis TX over the length of the grip part 42 in the front-rear direction, and the cross-sectional center HX is located above the drive axis TX in any position section of the grip part 42 in the front-rear direction. Where the line HL crosses the drive axis TX in any position of the grip part 42 in the front-rear direction, the up-down direction may be defined by other methods as shown in the other embodiments described below.

As shown in FIGS. 1 and 2, an upper end of the grip part 42 is formed to be substantially flush with an upper end of the motor housing 30. Thus, a lower outer surface of the handle housing 40 is upwardly recessed relative to a lower outer surface of the motor housing 30 and a lower outer surface of a rear end part of the handle housing 40. This lower recessed part of the handle housing 40 is also referred to as a handle recess 44.

As shown in FIG. 1, the tool housing 50 is connected to a front end of the motor housing 30. The tool housing 50 houses the spindle 90 and an illumination device DL. The tool housing 50 is formed to have a sectional width smaller than the sectional width of the motor housing 30 so as to have the sectional width and shape easy to hold. In this embodiment, the tool housing 50 is covered with an insulating material such as elastomer. A user can use the die grinder 100 while holding the grip part 42 of the handle housing 40 with one hand and holding the tool housing 50 with the other hand.

The illumination device DL is configured to irradiate light toward a working area including a workpiece and its surroundings. Visibility of a workpiece is improved by providing the illumination device DL. In this embodiment, the illumination device DL is arranged in a front end part of the tool housing 50.

A2. The Structure of Elements Disposed within the Die Grinder 100:

As shown in FIG. 4, the handle housing 40 houses a controller 10 and a switch 14. The controller 10 comprises a computer having a central processing unit CPU and memories such as a RAM and a ROM. The controller 10 controls driving of the motor 20 and other various operations in the die grinder 100.

The controller 10 is arranged such that the drive axis TX passes therethrough. This arrangement allows reduction in size of the housing HS in a radial direction. The controller 10 has a generally flat plate-like shape and is arranged in a rear end part of the handle housing 40 such that a surface direction of the controller 10 crosses the drive axis TX. The controller 10 is disposed in the rear end part of the handle housing 40 where a space is easily formed inside compared with the motor housing 30 and the tool housing 50, so that elements within the housing HS can be efficiently arranged.

In this embodiment, the battery mounting part 46 is provided on a rear end of the handle housing 40 and configured such that a battery BT is removably mounted thereto. The battery mounting part 46 is arranged in the rear end part of the handle housing 40 such that the drive axis TX passes therethrough. The battery BT is a known secondary battery such as a lithium-ion battery including cells.

In the example shown in FIG. 4, a mounting/removing direction DB of the battery BT is a direction orthogonal to the drive axis TX, and in this embodiment, coincident with the up-down direction. A user can remove the battery BT from the battery mounting part 46 by pulling out the battery BT upward along the mounting/removing direction DB. Further, the user can mount the battery BT to the battery mounting part 46 by pushing in the battery BT downward along the mounting/removing direction DB. The battery BT mounted to the battery mounting part 30 can supply power to the motor 20, the illumination device DL and the controller 10. The battery BT is electrically connected to a circuit substrate 70 via an electric wire 12 wired within the housing HS, to supply power to the illumination device DL.

As shown in FIG. 4, the motor housing 30 houses the motor 20. The motor 20 is a brushless DC motor that is driven under control of the controller 10. The motor 20 has a motor body 21 including a stator and a rotor, a motor shaft 22 and a fan 26 mounted onto the motor shaft 22. The fan 26 rotates together with the motor shaft 22. The fan 26 generates an air flow for cooling the motor 20.

The motor shaft 22 is supported to be rotatable relative to the motor housing 30 by a front motor bearing 201 and a rear motor bearing 202 that are disposed within the motor housing 30. The motor shaft 22 rotates around a motor rotation axis MX together with the rotor. In this embodiment, the motor shaft 22 is connected to the spindle 90 via a coupling 204 and configured such that the motor rotation axis MX is coincident with the drive axis TX. The motor rotation axis MX and the drive axis TX may however be not coincident, but, for example, may be parallel to each other while being closer to each other to such an extent that the drive axis TX passes through the motor body 21. The close arrangement of the motor rotation axis MX of the motor 20 and the drive axis TX allows reduction in size of the die grinder 100 in the radial direction.

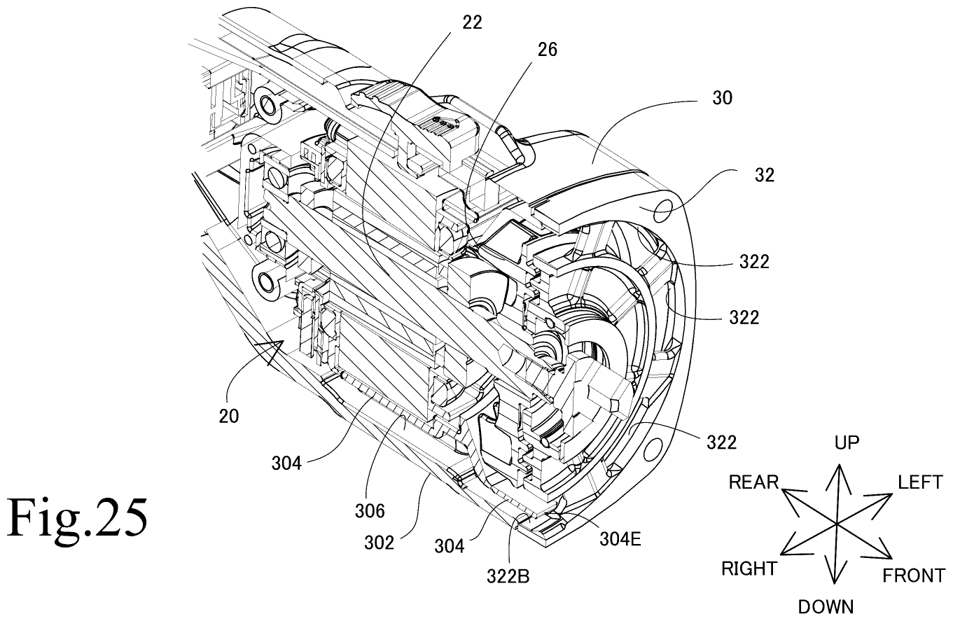

The front motor bearing 201 is supported within the motor housing 30 while being restricted from moving by a motor bearing retainer 32. The motor bearing retainer 32 has openings 322 (see FIG. 25) that serve as vent holes through which air flow from the fan 26 passes.

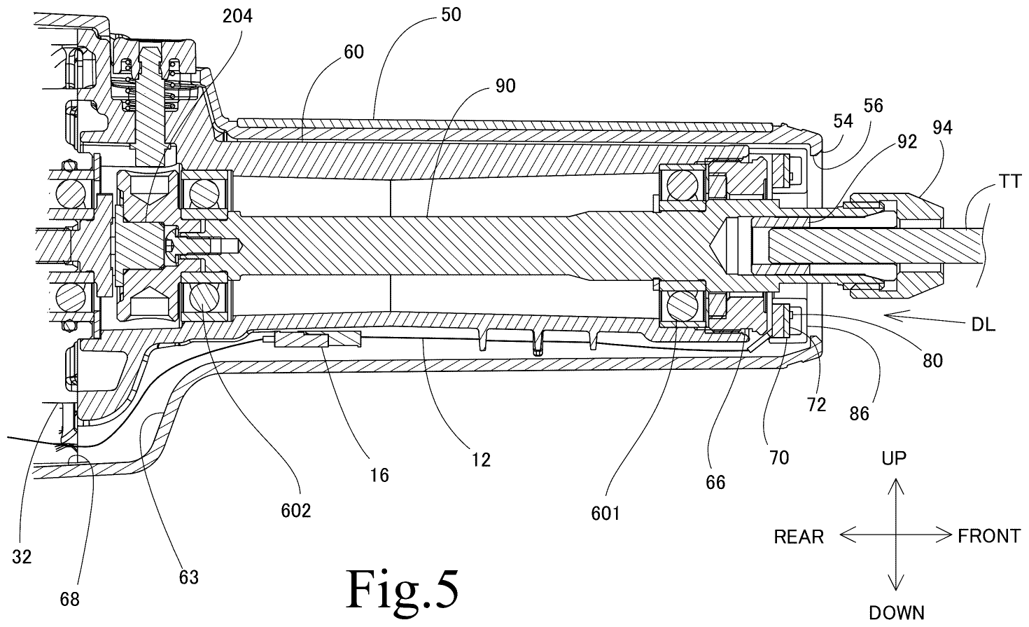

As shown in FIG. 5, the tool housing 50 houses a barrel 60 and the illumination device DL. The barrel 60 houses the spindle 90. The spindle 90 is supported to be rotatable relative to the barrel 60 by front and rear spindle bearings 601, 602 that are held within the barrel 60. The front spindle bearing 601 is fixed (fixedly retained) by a bearing retainer 66 and restricted from moving in the front-rear direction. A collet cone 92 for fixing the tool accessory TT, and a collet nut 94 are mounted to a front end part of the spindle 90. The tool accessory TT is inserted into the collet cone 92, and mounted unrotatably to the spindle 90 by tightening the collet nut 94.

As shown in FIG. 4, in this embodiment, an operation part SW1 for on-off operation of the motor 20 is arranged on the upper end of the motor housing 30. In the example shown in FIG. 4, a slide switch is used as the operation part SW1. By operating the slide switch, the switch 14 is turned on and off to turn on and off the motor 20. The operation part SW1 is not limited to a slide switch, and a touch sensor or other various kinds of switches may be used. When the motor 20 is turned on by operation of the operation part SW1, the motor shaft 22 is driven, and the spindle 90 and the tool accessory TT rotate together with the motor shaft 22 via the coupling 204.

As shown in FIG. 4, the illumination device DL is arranged in a front end part of the housing HS, or specifically, between a front end of the barrel 60 and a front end of the tool housing 50 within the tool housing 50. In this embodiment, the illumination device DL is configured to irradiate light LT to a workpiece WS placed below the die grinder 100.

As shown in FIG. 5, the illumination device DL includes a light emitting part 80, a protection member 86 and a circuit substrate 70. The light emitting part 80 is an LED light using the battery BT as a power source. The light emitting part 80 is covered with the protection member 86 formed of transparent resin. The protection member 86 transmits light emitted from the light emitting part 80. The protection member 86 may be formed of glass, for example, when having no claws 864 described below.

The circuit substrate 70 is a so-called LED substrate, and the light emitting part 80 is mounted on a front surface 72 of the circuit substrate 70. The electric wire 12 is connected to the circuit substrate 70 to supply power from the battery BT. The front surface 72 of the circuit substrate 70 has an annular shape surrounding the drive axis TX and having an opening in the center through which the spindle 90 is inserted. In this embodiment, three light emitting parts 80 are assembled on the circuit substrate 70. Arrangement of the light emitting parts 80 will be described below.

In this embodiment, the die grinder 100 is configured such that the light emitting parts 80 are turned on and off in interlocking with on-off operation of the operation part SW1. Light LT is emitted from the illumination device DL and irradiated to a workpiece WS from an opening 56 of the front end of the tool housing 50.

### A3. A Method of Assembling the Illumination Device DL:

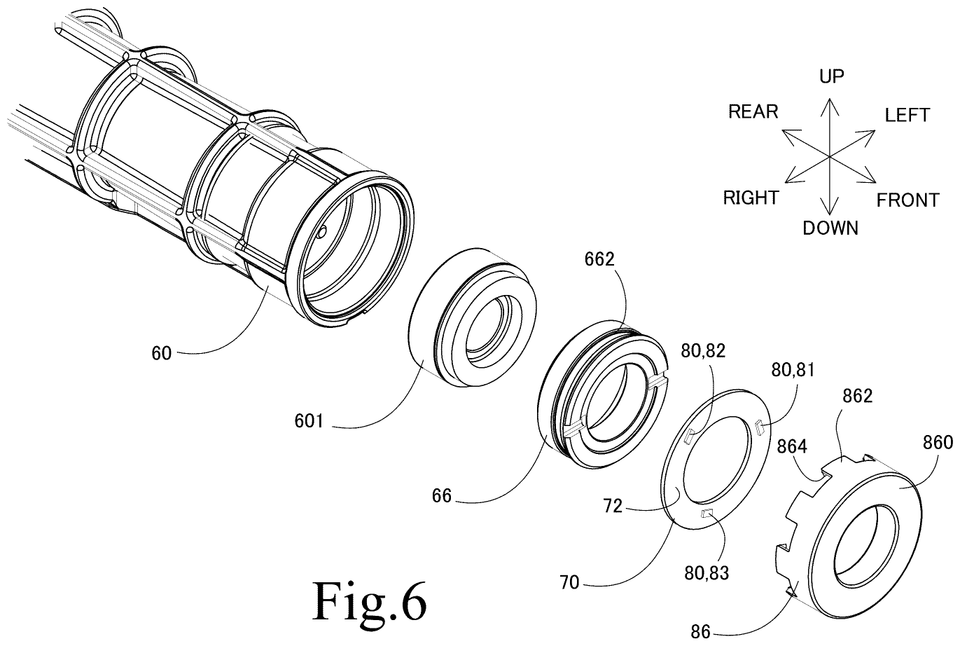

A method of assembling the illumination device DL to the barrel 60 is now described with reference to FIG. 6. In FIG. 6, for easy understanding of technology, a part of members including the spindle 90 is not shown. First, the spindle 90 with the front spindle bearing 601 mounted thereon is inserted into the barrel 60 from the front end of the barrel 60.

Next, the front spindle bearing 601 is fixed to the barrel 60 by the bearing retainer 66 being mounted to the front end of the barrel 60. A male thread (not shown) is formed on an outer peripheral surface of the bearing retainer 66. The male thread of the bearing retainer 66 is screwed to a female thread (not shown) formed on an inner peripheral surface of the front end part of the barrel 60. When the bearing retainer 66 is screwed to the front end part of the barrel 60, the bearing retainer 66 is fixed to the front end part of the barrel 60 while restricting movement of the front spindle bearing 601 in the front-rear direction. In addition to the male thread, a recess 662 having a shape corresponding to the claws 864 is formed in the outer peripheral surface of the bearing retainer 66.

Subsequently, the protection member 86 is fixed to the bearing retainer 66. In this embodiment, the die grinder 100 is configured such that the protection member 86 is fixed to the bearing retainer 66 by so-called snap fit. Provision of the snap-fit structure facilitates mounting and removal of the protection member 86, which facilitates repair of the illumination device DL.

The circuit substrate 70 with the light emitting parts 80 mounted thereon is fixed to the protection member 86 by an adhesive or the like. The protection member 86 has a generally annular body part 860 that covers the front surface 72 of the circuit substrate 70, a base part 862 protruding rearward from an outer periphery of the body part 860, and claws 864 formed on a protruding end of the base part 862. The claws 864 protrude radially inward from the outer periphery of the body part 860.

The protection member 86 is formed of elastic transparent resin. Thus, when the protection member 86 is moved rearward toward the bearing retainer 66, the claws 864 abut on an outer peripheral surface of the bearing retainer 66 and are bent in a direction away from the bearing retainer 66 by receiving reaction force from the outer peripheral surface. When the protection member 86 is further moved rearward, the claws 864 are released from the reaction force from the outer peripheral surface and engaged with the recess 662 of the bearing retainer 66.

In this embodiment, by provision of the structure configured such that the protection member 86 is fixed to the bearing retainer 66, compared with a structure in which the protection member 86 is engaged with an outer peripheral surface of the barrel 60, increase in size of the protection member 86 in the radial direction can be suppressed, and increase in size of the tool housing 50 in the radial direction can be suppressed or restricted.

When the protection member 86 is fixed to the bearing retainer 66, the circuit substrate 70 is held between the protection member 86 and the bearing retainer 66 with the claws 864 and the recess 662 engaged with each other. As a result, the illumination device DL is fixed to the bearing retainer 66 and the barrel 60.

In this manner, the spindle 90, the bearing retainer 66 and the protection member 86 are fixed to the barrel 60. Subsequently, the tool housing 50 is fitted onto the barrel 60. The protection member 86 is fixed in such a manner as to be restricted from moving in the front-rear direction by an inner peripheral surface of a protrusion 54, while being exposed to the outside from the front end opening 56 of the tool housing 50 as shown in FIG. 5. The protrusion 54 protrudes radially inward from the front end of the tool housing 50 and defines the opening 56.

The illumination device DL is fixed in front of the front end of the barrel 60. Compared with a structure in which the illumination device DL is disposed within the barrel 60 and a structure in which the protection member 86 is engaged with an inner peripheral surface of the barrel 60, this structure facilitates mounting and removal of the protection member 86, and thus facilitates repair of the illumination device DL. The structure of the die grinder 100 is not limited to these. For example, the recess 622 may be formed in a member other than the bearing retainer 66, such as the inner or outer peripheral surface of the barrel 60. Where the recess 622 is formed in the inner peripheral surface of the barrel 60, the claws 864 are formed to protrude radially outward from the base part 862.

### A4: The Arrangement of the Light Emitting Parts 80 on the Circuit Substrate 70:

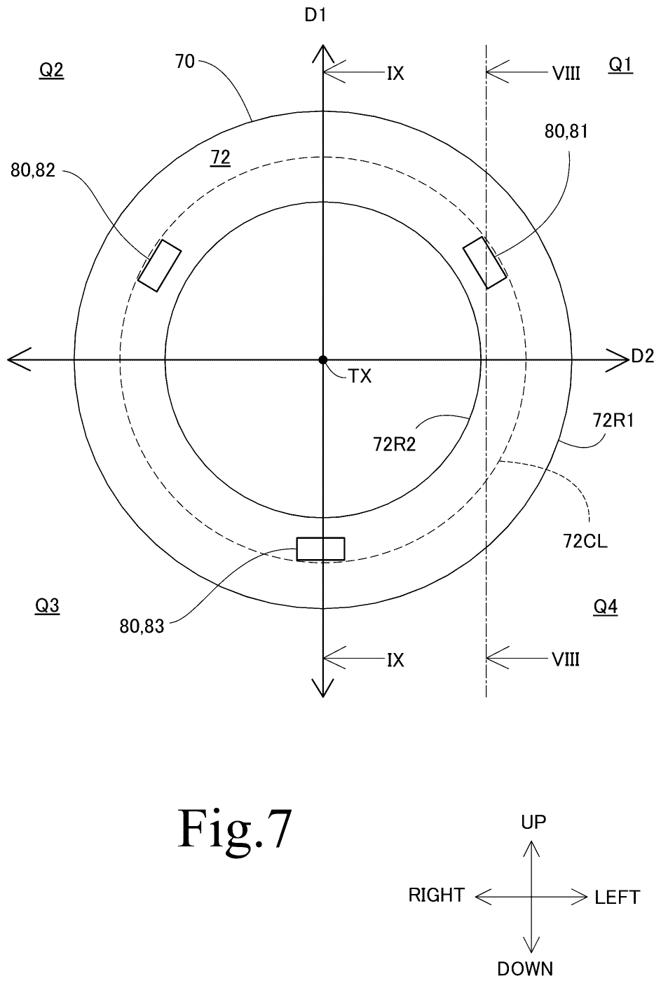

The arrangement position of the light emitting parts 80 on the circuit substrate 70 is now described with reference to FIGS. 7 to 21. As shown in FIG. 7, the front surface 72 of the circuit substrate 70 is divided into four quadrants by a line passing the drive axis TX in the up-down direction D1 and a line passing the drive axis TX in the left-right direction D2 orthogonal to the up-down direction D1. Specifically, the upper right quadrant relative to the drive axis TX is defined as a first quadrant Q1, the upper left quadrant as a second quadrant Q2, the lower left quadrant as a third quadrant Q3, and the lower right quadrant as a fourth quadrant Q4. The light emitting parts 80 include at least a first light emitting part 81 arranged in the first quadrant Q1 and a second light emitting part 82 arranged in the second quadrant Q2. The first and second light emitting parts 81, 82 are arranged in respective positions at an elevation angle of 30 degrees to the left-right direction D2.

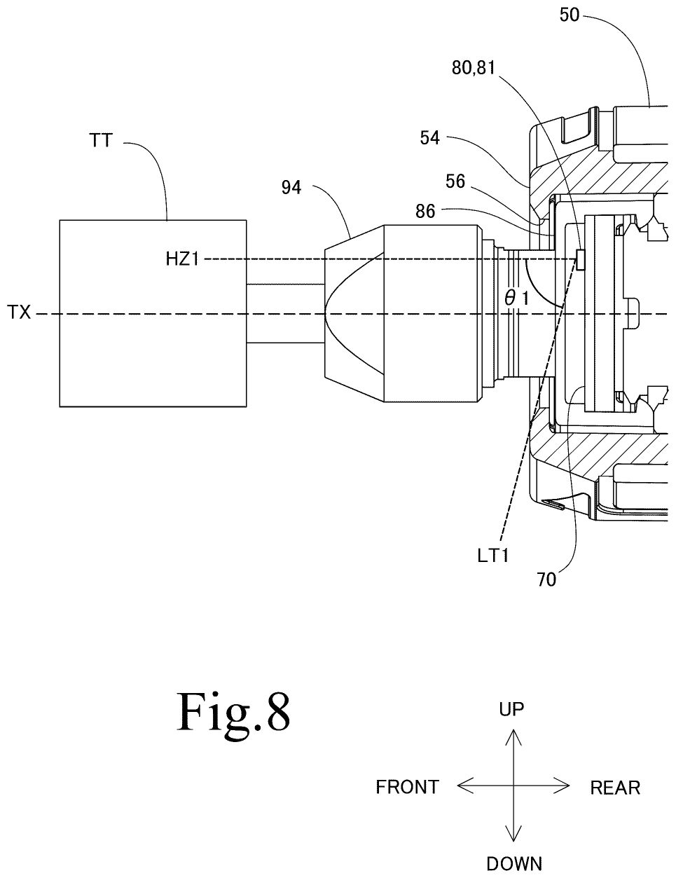

In FIG. 8, a simulation result of the light irradiation range of the first light emitting part 81 is schematically shown. A simulation result of the light irradiation range of the second light emitting part 82 is identical to that of the first light emitting part 81 and is therefore not described. As shown in FIG. 8, light is irradiated from the first light emitting part 81 to the outside of the die grinder 100 via the front end opening 56 of the tool housing 50. Thus, the light irradiation range of the first light emitting part 81 can be defined by the front end protrusion 54 of the tool housing 50. In this embodiment, an angle θ1 between a horizontal plane HZ1 passing the first light emitting part 81 and light LT1 that is irradiated downward at the maximum angle from the first light emitting part 81 is 75.1 degrees in the light irradiation range of the first light emitting part 81.

Referring to FIG. 7, in the die grinder 100 of this embodiment, the light emitting parts 80 further include a third light emitting part 83 arranged right below the drive axis TX on the front surface 72. Arrangement of the third light emitting part 83 right below the drive axis TX improves illuminance of an area below the die grinder 100 while suppressing upward light irradiation of the light emitting parts 80. Thus, the light emitting parts 80 are suitably arranged to improve the visibility of the workpiece WS while suppressing user's discomfort due to the light irradiation.

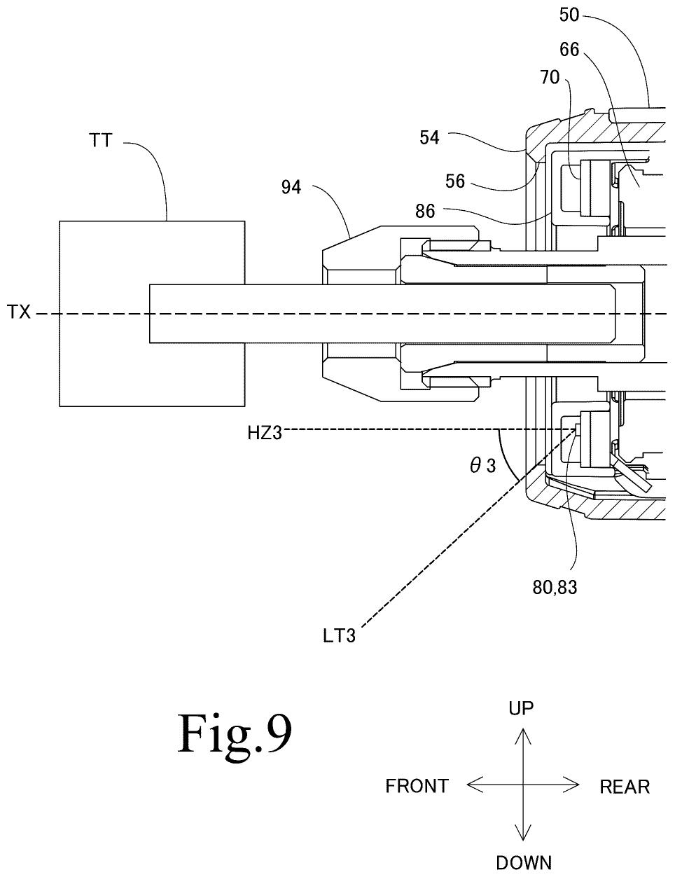

In FIG. 9, a simulation result of the light irradiation range of the third light emitting part 83 is schematically shown. As shown in FIG. 9, an angle θ3 between a horizontal plane HZ3 passing the third light emitting part 83 and light LT3 that is irradiated downward at the maximum angle from the third light emitting part 83 is 42.8 degrees.

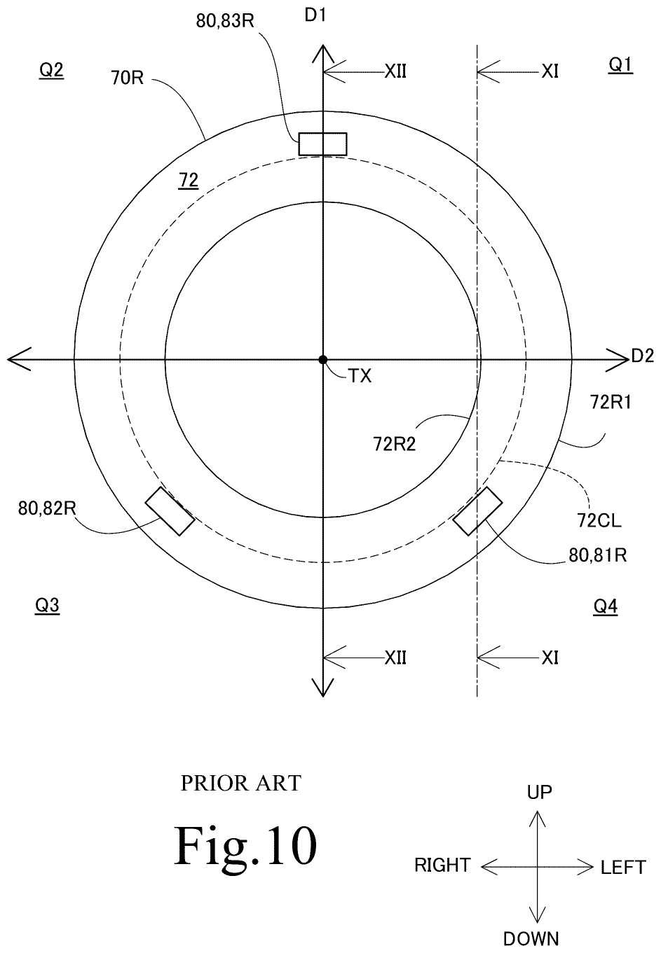

A first comparative example is now described as to the irradiation range of the illumination device DL of a die grinder 100R, which is different in arrangement of the light emitting parts 80 from the die grinder 100 of this embodiment, with reference to FIGS. 10 to 12. As shown in FIG. 10, in the comparative example, three light emitting parts 80 are provided on a circuit substrate 70R. Specifically, the light emitting parts 80 include a first light emitting part 81R arranged in the fourth quadrant Q4, a second light emitting part 82R arranged in the third quadrant Q2, and a third light emitting part 83R arranged right above the drive axis TX.

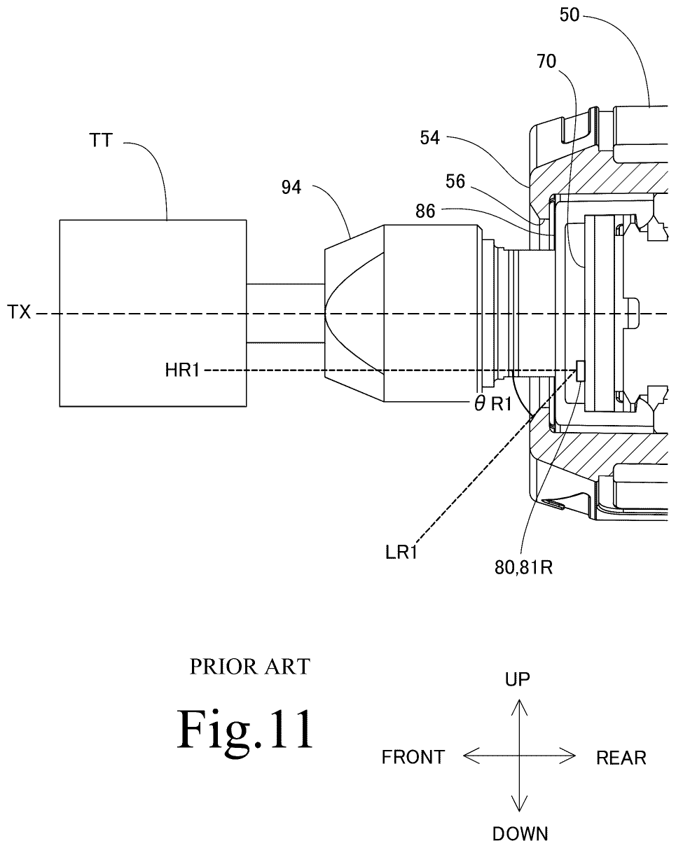

In FIG. 11, a simulation result of the light irradiation range of the first light emitting part 81R is schematically shown. As shown in FIG. 11, an angle θR1 between a horizontal plane HR1 passing the first light emitting part 81R and light LR1 that is irradiated downward at the maximum angle from the first light emitting part 81R is 47.3 degrees in the light irradiation range of the first light emitting part 81R.

In order to compare the light irradiation range of the light emitting parts 80 arranged on the lateral sides of the drive axis TX, the first light emitting part 81 of the die grinder 100 of this embodiment is compared with the first light emitting part 81R of the die grinder 100R of the comparative example. The angle θ1 in the light irradiation range of the die grinder 100 of this embodiment shown in FIG. 8 is larger than the angle θR1 in the light irradiation range of the die grinder 100R of the comparative example shown in FIG. 11. Specifically, the irradiation range of light irradiated downward by the first and second light emitting parts 81, 82, which are arranged on the lateral sides of the drive axis TX in the die grinder 100 of this embodiment, is wider than that of the comparative example.

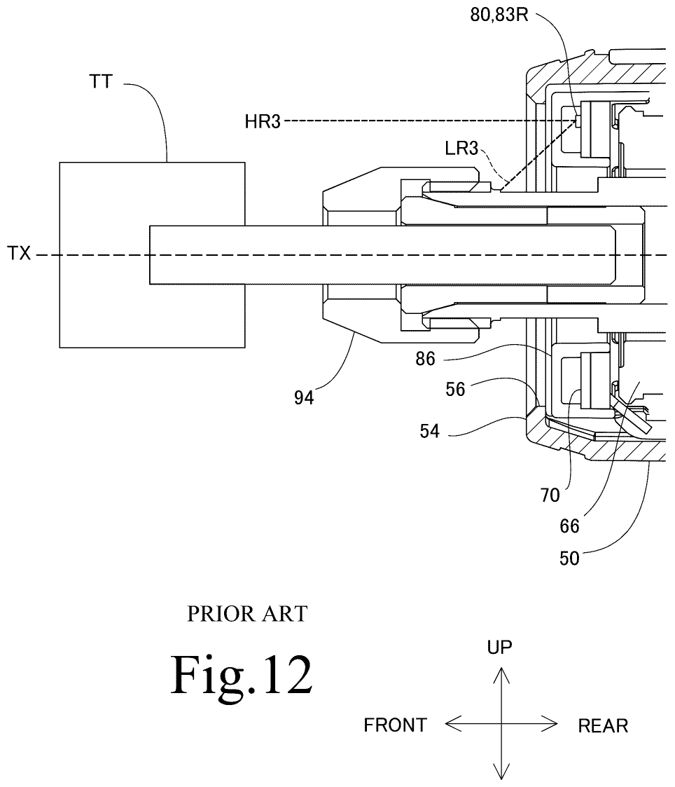

In FIG. 12, a simulation result of the light irradiation range of the third light emitting part 83R is schematically shown. As shown in FIG. 12, members such as the spindle 90, the collet nut 94 and the tool accessory TT are arranged right below the third light emitting part 83R. Thus, light LR3 that is irradiated downward from the third light emitting part 83R is intercepted by these members.

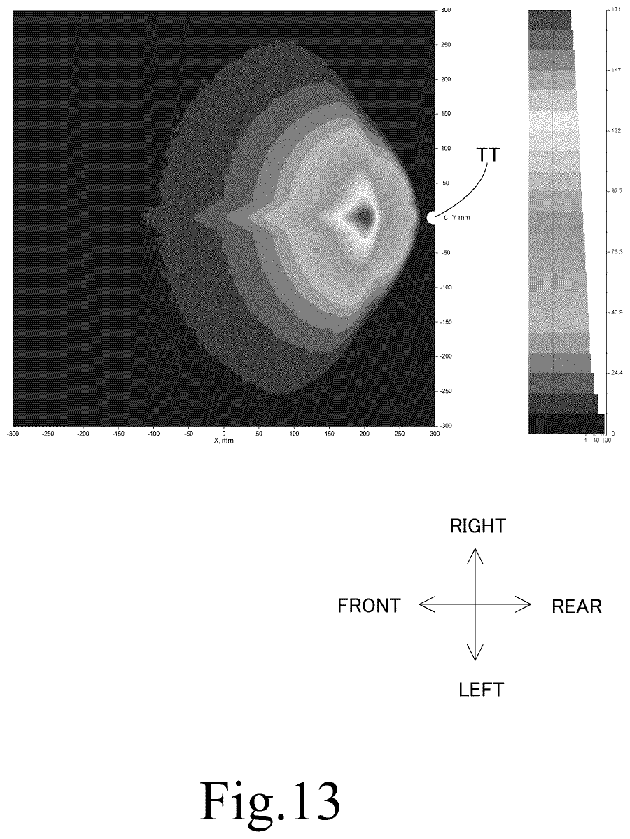

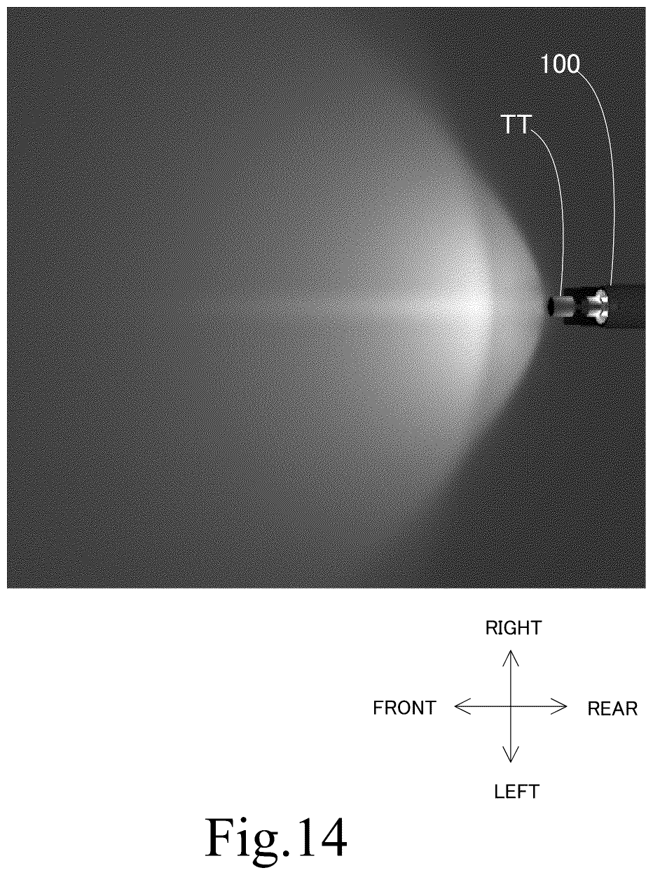

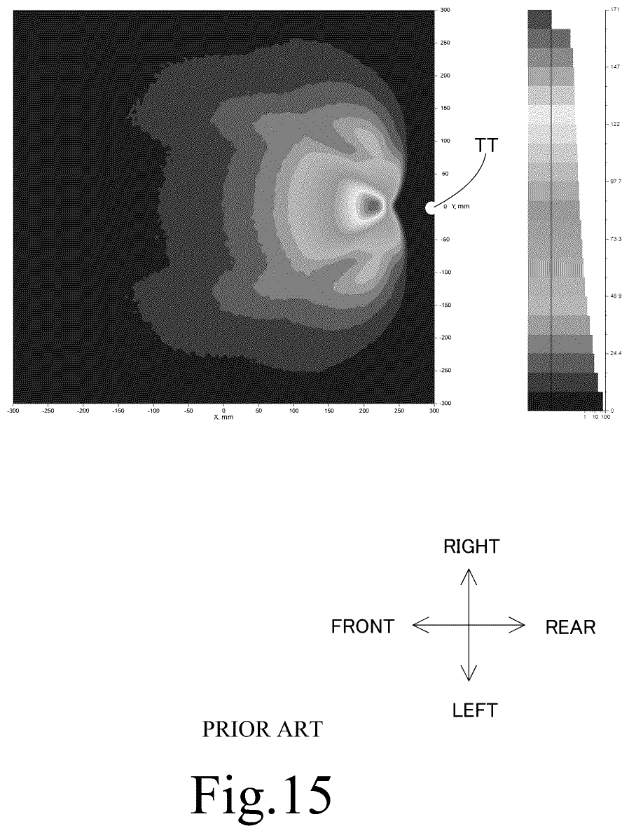

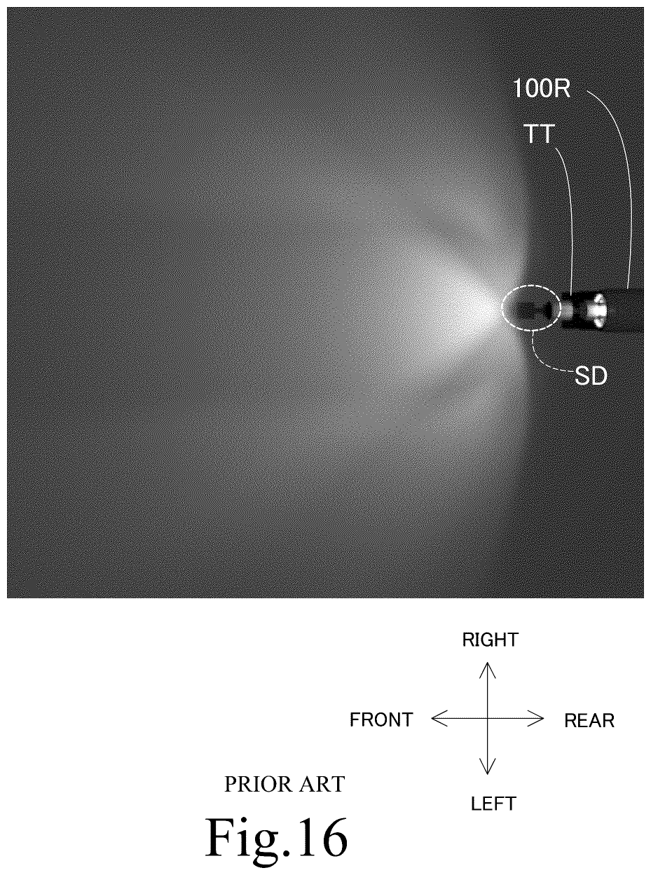

FIGS. 13 and 14 schematically show simulation results of light irradiated downward by the die grinder 100 of this embodiment, and FIGS. 15 and 16 schematically show simulation results of light irradiated downward by the die grinder 100R of the comparative example. The irradiation range of light irradiated downward by the first and second light emitting parts 81, 82 of the die grinder 100 of this embodiment is wider than that of the comparative example, and the first and second light emitting parts 81, 82 can irradiate an area closer to the tool accessory TT than the comparative example. In the case of the die grinder 100R of the comparative example, however, illuminance is low in the vicinity of the tool accessory TT.

As shown in FIGS. 15 and 16, the die grinder 100R of the comparative example does not diffuse light uniformly in the left-right direction in front of the tool accessory TT. On the other hand, as shown in FIGS. 13 and 14, the die grinder 100 of this embodiment diffuses light uniformly in the left-right direction in front of the tool accessory TT, and achieve high illuminance in a wider area in front of the tool accessory TT than the comparative example.

Further, as shown in FIG. 16, the die grinder 100R of the comparative example forms a shadow SD of the tool accessory TT by the light LR3 irradiated downward from the third light emitting part 83R. The die grinder 100 of this embodiment, however, does not form the shadow SD of the tool accessory TT, and thus realizes higher visibility of the irradiation range than the comparative example. Consequently, the die grinder 100 of this embodiment improves the visibility of the workpiece WS below the tool accessory TT.

In the die grinder 100 of this embodiment, as shown in FIG. 7, the light emitting parts 80 are arranged in an inner region closer to the drive axis TX in the radial direction on the front surface 72 of the circuit substrate 70, which is specifically described as follows.

In FIG. 7, an intermediate circle 72CL between outer and inner peripheries of the front surface 72 is schematically shown. Specifically, the intermediate circle 72CL is a circle formed along an intermediate position between an outer periphery 72R1 and an inner periphery 72R2 closer to the drive axis TX in the radial direction. In the die grinder 100 of this embodiment, the first, second and third light emitting parts 81, 82, 83 are arranged in the inner region closer to the drive axis TX inside of the intermediate circle 72CL in the radial direction on the front surface 72.

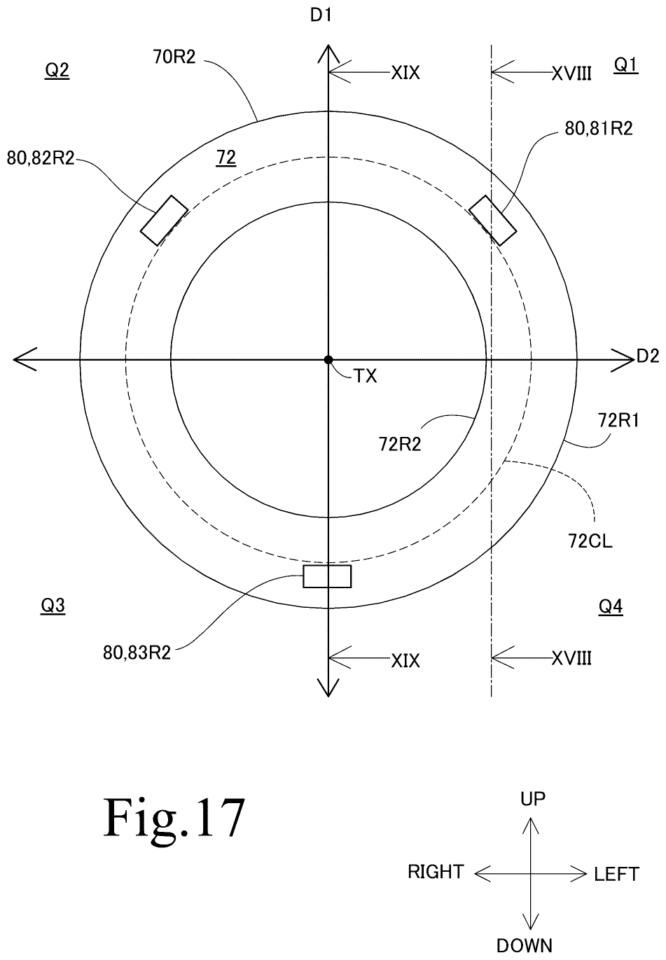

A second comparative example is now described as to the irradiation range of the light emitting parts 80 arranged in an outer region (on the outer side) apart from the drive axis TX in the radial direction, with reference to FIGS. 17 to 21. As shown in FIG. 17, like the circuit substrate 70 of the die grinder 100 of this embodiment, on a circuit substrate 70R2 of a die grinder 100R2 of the second comparative example, three light emitting parts 80 are respectively arranged in the first and second quadrants Q1, Q2 and right below the drive axis TX. The second comparative example is different from this embodiment in that first, second and third light emitting parts 81R2, 82R2, 83R2 are arranged in the outer region outside of the intermediate circle 72CL apart from the drive axis TX in the radial direction. The first and second light emitting parts 81R2, 82R2 are arranged in respective positions at an elevation angle of 30 degrees to the left-right direction D2. A simulation result of the light irradiation range of the second light emitting part 82R2 is identical to that of the first light emitting part 81R2 and is therefore not described.

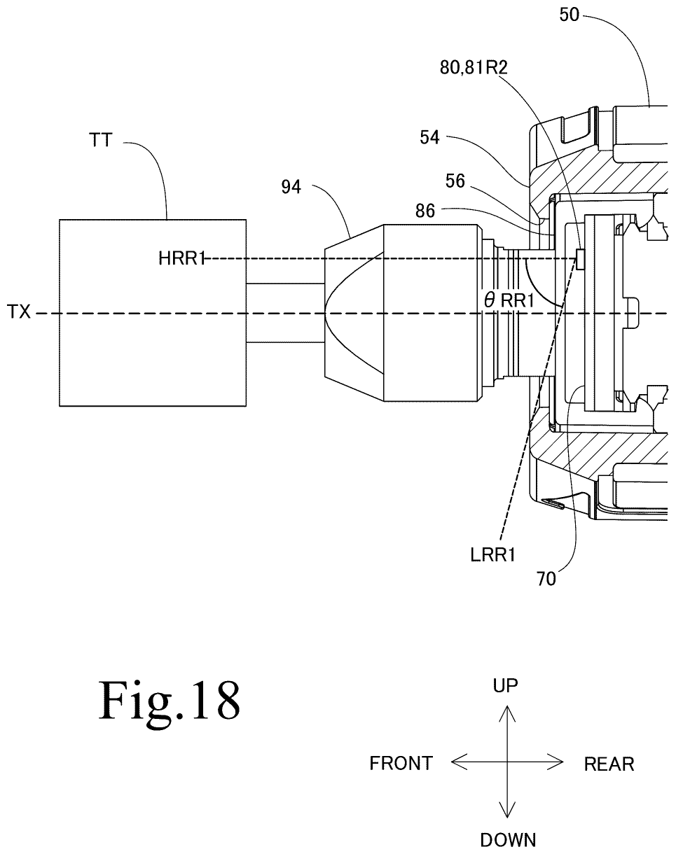

In FIG. 18, a simulation result of the light irradiation range of the first light emitting part 81R2 is schematically shown. As shown in FIG. 18, an angle θPR1 between a horizontal plane HRR1 passing the first light emitting part 81R2 and light LRR1 that is irradiated downward at the maximum angle from the first light emitting part 81R2 is 75.0 degrees in the light irradiation range of the first light emitting part 81R2. Thus, the irradiation range of light irradiated forward by the first light emitting part 81 of the die grinder 100 of this embodiment is slightly wider than that of the second comparative example. The irradiation range of light irradiated forward by the first light emitting part 81 of the die grinder 100 of this embodiment is slightly wider than that of the second comparative example. The light irradiation range of the first light emitting part 81R2 of the second comparative example is however wider than that of the first light emitting part 81R of the die grinder 100R of the first comparative example.

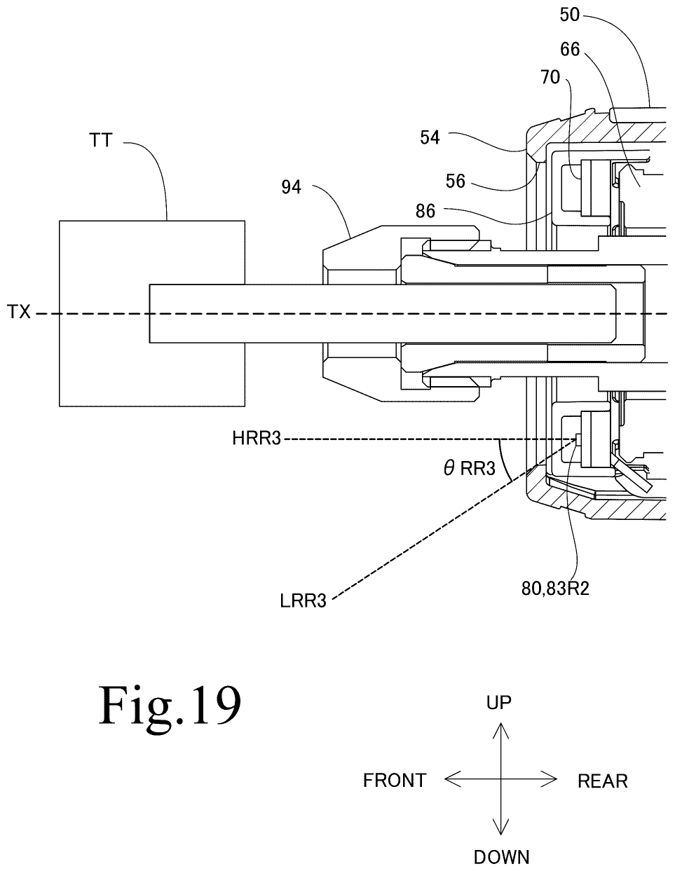

In FIG. 19, a simulation result of the light irradiation range of the third light emitting part 83R2 is schematically shown. As shown in FIG. 19, an angle θRR3 between a horizontal plane HRR3 passing the third light emitting part 83R2 and light LRR3 that is irradiated downward at the maximum angle from the third light emitting part 83R2 is 33.3 degrees. Thus, the light irradiation range of the third light emitting part 83 of the die grinder 100 of this embodiment is wider than that of the third light emitting part 83R2 of the second comparative example. The light irradiation range of the third light emitting part 83R2 of the die grinder 100R2 of the second comparative example is however wider than that of the third light emitting part 83R of the die grinder 100R of the first comparative example.

From the above-described comparison of the simulation results, the light irradiation range of the first and second light emitting parts 81, 82 is wider when the first and second light emitting parts 81, 82 are arranged in the first and second quadrants Q1, Q2 than when they are arranged in the third and fourth quadrants Q3, Q4, and is further wider when they are arranged inside of the intermediate circle 72CL than when they are arranged outside of the intermediate circle 72CL in the radial direction.

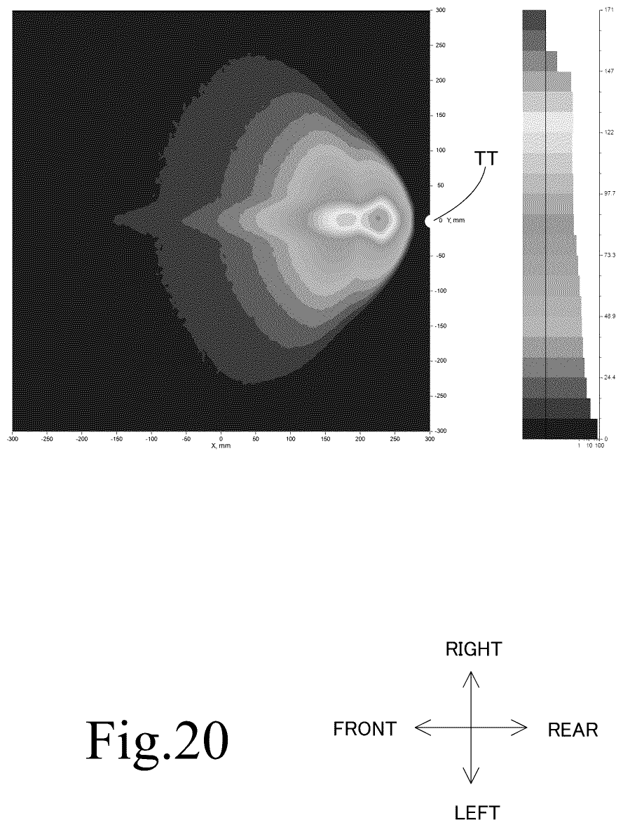

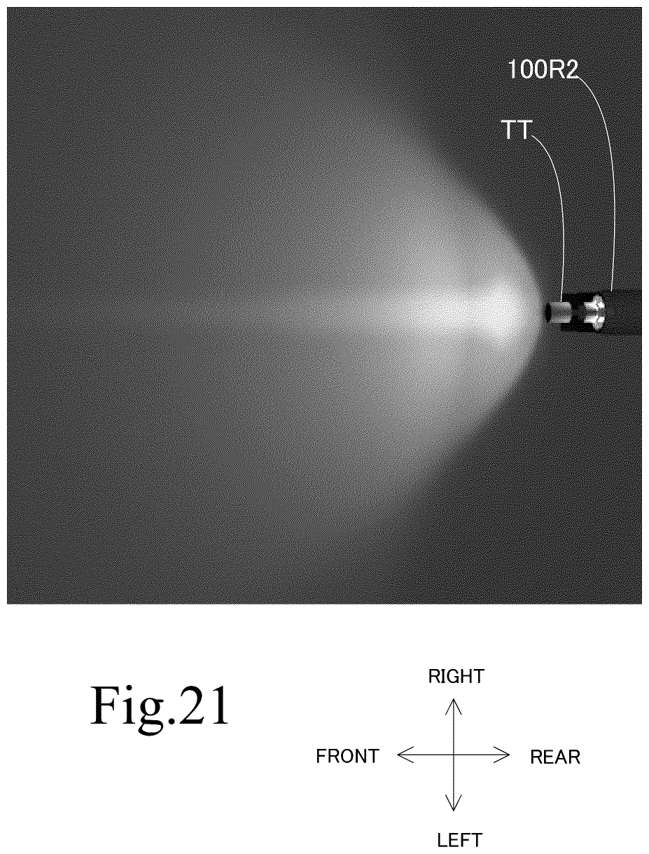

As shown in FIGS. 20 and 21, in the downward light irradiation range of the die grinder 100R2 of the second comparative example, compared with the die grinder 100R of the comparative example shown in FIGS. 15 and 16, an area in which illuminance is high in front of the tool accessory TT is wider, and light is diffused uniformly in the left-right direction in front of the tool accessory TT, so that the visibility is improved. The irradiation range of the die grinder 100 of this embodiment is wider than that of the die grinder 100R2 of the second comparative example. Specifically, the die grinder 100 of this embodiment can achieve high illuminance in a much wider area in front of the tool accessory TT than the second comparative example.

A5: The Structure for Arrangement of the Wire 12 within the Die Grinder 100

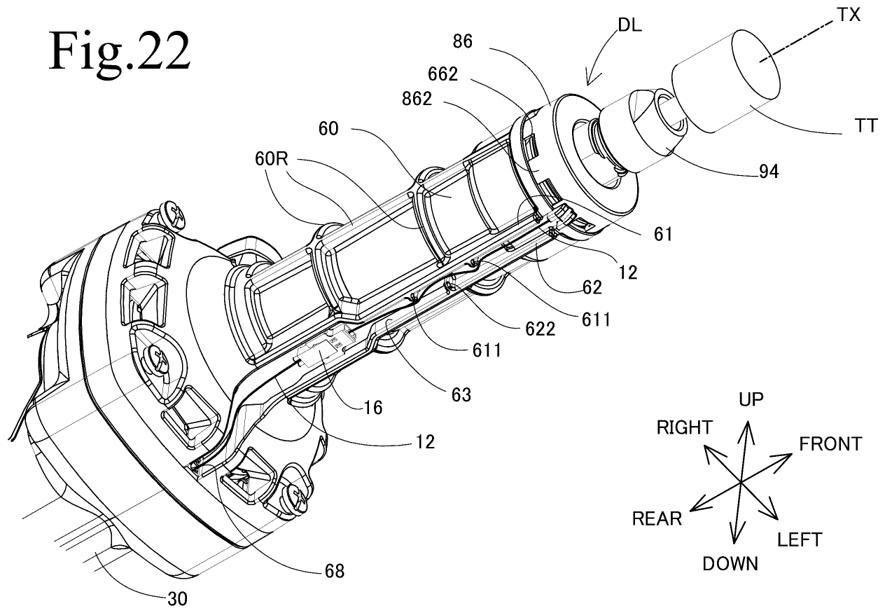

FIG. 22 shows the structure of a lower side of the die grinder 100 with the tool housing 50 removed therefrom. As shown in FIG. 22, a wire 12 connected to the illumination device DL is connected via a connector 16 to a wire 12 connected to the controller 10, which is specifically described as follows.

The wire 12 connected to the illumination device DL is led rearward along a lower outer surface of the barrel 60, and then led into the housing HS through a through hole 68 formed in the barrel 60.

As shown in FIG. 22, ribs 60R are formed on the outer surface of the barrel 60 for the purposes of weight reduction and reinforcement of the barrel 60. In the die grinder 100 of this embodiment, a wiring path of the wire 12 is efficiently formed by utilizing the rib 60R formed on the lower surface of the barrel 60.

As shown in FIG. 22, first and second wall parts 61, 62 are formed to protrude from the outer surface of the barrel 60 on the lower side of the barrel 60. The first and second wall parts 61, 62 also serve as the rib 60R. The first and second wall parts 61, 62 extend rearward along the barrel 60 and are arranged close to each other.

The wire 12 led from the illumination device DL is arranged in a barrel wire path 63 that is defined between the first and second wall parts 61, 62. The wiring path of the wire 12 is efficiently formed around the barrel 60 by provision of the first and second wall parts 61, 62 that also serve as the rib 60R. Further, increase in size of the tool housing 50 and the barrel 60 in the radial direction can be suppressed compared with a structure in which a wiring path different from the rib 60R is newly formed on the tool housing 50 or the barrel 60.

As shown in FIG. 22, in the die grinder 100 of this embodiment, protrusions are formed between the first and second wall parts 61, 62 to reduce the possibility that the wire 12 comes off from the barrel wire path 63. Specifically, a first protrusion 611 is formed on a surface of the first wall part 61 facing the second wall part 62 and protrudes toward the second wall part 62. A second protrusion 622 is formed on a surface of the second wall part 62 facing the first wall part 61 and protrudes toward the first wall part 61.

The numbers of the first and second protrusions 611, 622 may be arbitrarily selected. In this embodiment, two first protrusions 611 and one second protrusion 622 are provided. The first protrusions 611 and the second protrusion 622 are arranged alternately in the front-rear direction. With this arrangement, the wire 12 can be arranged in the barrel wire path 63 while being curved in the left-right direction. Thus, the wire 12 is more reliably restrained or prevented from coming off from the barrel wire path 63.

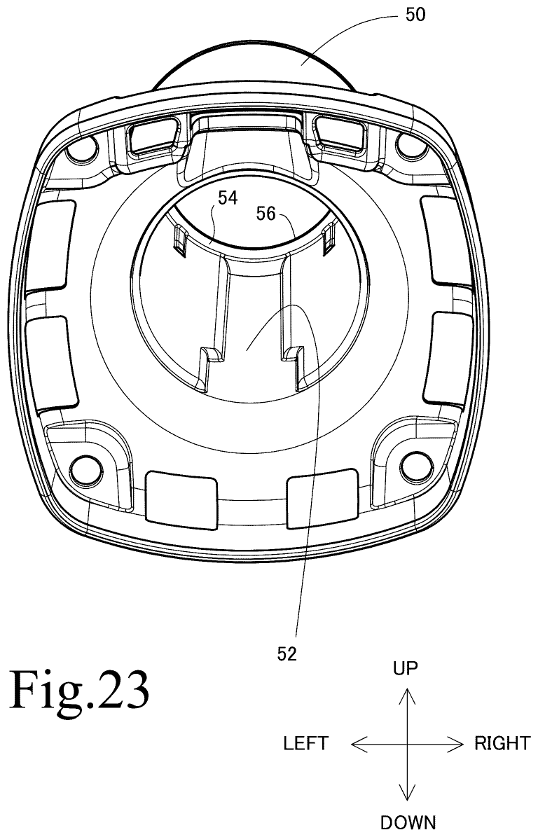

As shown in FIG. 23, a recess 52 is formed in an inner peripheral surface of the tool housing 50. The recess 52 is formed into such a shape and in such a position as to receive the first and second wall parts 61, 62 of the barrel 60. With this structure, the unevenness of the outer surface of the barrel 60 due to the presence of the first and second wall parts 61, 62 is absorbed, so that the tool housing 50 can be formed into a smooth cylindrical shape. Further, the tool housing 50 is restricted from rotating relative to the barrel 60 by the first and second wall parts 61, 62 being received in the recess 52. Therefore, the tool housing 50 is easy to hold, so that the die grinder 100 is provided with high operability.

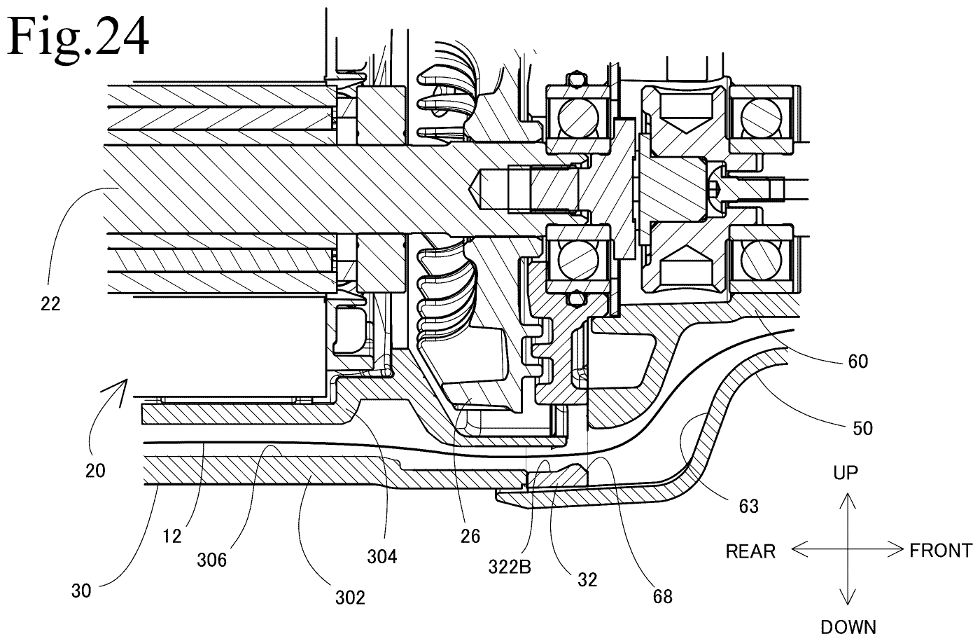

In the die grinder 100 of this embodiment, as shown in FIG. 24, a motor wire path 306 is provided inside the motor housing 30 such that the wire 12 led into the housing HS through the through hole 68 of the barrel 60 is led into the handle housing 40 therethrough, which is specifically described as follows.

As shown in FIG. 24, a support wall part 304 is formed in a lower part of the motor housing 30 to support the motor body 21 under the motor body 21. The motor wire path 306 is a space defined between the support wall part 304 and an outer wall part 302 of the motor housing 30. By providing the motor wire path 306, the wire 12 led from the tool housing 50 is passed therethrough into a rear part of the housing HS, or the handle housing 40, while being restrained from coming into contact with elements disposed within the motor housing 30. Further, increase in size of the motor housing 30 in the left-right direction can be suppressed or prevented.

Further, in the die grinder 100 of this embodiment, one of the openings 322 that are formed in the motor bearing retainer 32 and serve as vent holes also serves as a wiring path of the wire 12. Specifically, as shown in FIG. 25, a front end 304E of the support wall part 304 extends into one of the openings 322 or an opening 322B that is arranged below the drive axis TX in the motor bearing retainer 32. Further, as shown in FIG. 24, the through hole 68 formed in the motor housing 30 is arranged to face a front end of the motor wire path 306 via the opening 322B. Thus, the barrel wire path 63, the opening 322B and the motor wire path 306 are configured to communicate with each other.

In the die grinder 100 of this embodiment, increase in size of the motor housing 30 in the radial direction can be reduced or prevented by utilizing one of the vent holes of the motor bearing retainer 32 as a wiring path of the wire 12, compared with a structure in which the wiring path is formed to bypass the motor bearing retainer 32. For example, downward protrusion of the outer shape of the motor housing 30 can be suppressed or reduced. Further, by utilizing the opening 322 formed as the vent hole in the motor bearing retainer 32, the wiring path of the wire 12 that connects the tool housing 50 and the motor housing 30 can be formed without changing the design of the motor bearing retainer 32.

In the die grinder 100 of this embodiment, as described above, the light emitting parts 80 include at least the first light emitting part 81 arranged in the upper right quadrant relative to the drive axis TX, and the second light emitting part 82 arranged in the upper left quadrant relative to the drive axis TX. The die grinder 100 of this embodiment diffuses light, which is emitted forward of the tool accessory TT, uniformly in the left-right direction, and achieves high illuminance in a wider area on the workpiece WS placed below the die grinder 100. Consequently, the die grinder 100 improves the visibility of the workpiece WS below the tool accessory TT.

In the die grinder 100 of this embodiment, the light emitting parts 80 further include the third light emitting part 83 arranged right below the drive axis TX. Arrangement of the third light emitting part 83 right below the drive axis TX improves illuminance on the workpiece WS placed below the die grinder 100 while suppressing upward irradiation of the light LT of the light emitting parts 80. Thus, the light emitting parts 80 are suitably arranged to improve the visibility of the workpiece WS while reducing user's discomfort due to the light irradiation.

In the die grinder 100 of this embodiment, the light emitting parts 80 are arranged in the inner region inside of the intermediate circle 72CL in the radial direction on the front surface 72. The die grinder 100 of this embodiment can irradiate light in a wider range onto the workpiece WS, compared with a structure in which the light emitting parts 80 are arranged in the outer region outside of the intermediate circle 72CL in the radial direction.

The die grinder 100 of this embodiment has the protection member 86 that is provided in front of the light emitting parts 80 and transmits the light LT of the light emitting parts 80. The protection member 86 has the base part 862 extending rearward from the body part 860, and claws 864 formed on the protruding end of the base part 862. The claws 864 are configured to be engaged with the recess 662 that is formed in a member arranged rearward of the circuit substrate 70. Provision of the snap fit structure facilitates mounting and removal of the illumination device DL, which facilitates repair of the illumination device DL.

In the die grinder 100 of this embodiment, the recess 662 is formed in the outer surface of the bearing retainer 66. The circuit substrate 70 and at least two light emitting parts 80 are held between the protection member 86 and the bearing retainer 66 with the claws 864 and the recess 662 engaged with each other. Compared with a structure in which the protection member 86 is engaged with the outer peripheral surface of the barrel 60, increase in size of the protection member 86 in the radial direction can be suppressed, and increase in size of the tool housing 50 in the radial direction can be suppressed or prevented.

In the die grinder 100 of this embodiment, the barrel 60 has the first and second wall parts 61, 62 protruding from the outer surface of the barrel 60. The wire 12 connected to the circuit substrate 70 is arranged in the barrel wire path 63 that is defined by the first and second wall parts 61, 62. The wire 12 is efficiently arranged around the barrel 60, while the barrel 60 is reinforced by the first and second wall parts 61, 62.

In the die grinder 100 of this embodiment, the first protrusion 611 is formed on a surface of the first wall part 61 facing the second wall part 62 and protrudes toward the second wall part 62. The second protrusion 622 is formed on a surface of the second wall part 62 facing the first wall part 61 and protrudes toward the first wall part 61. The wire 12 can be arranged in the barrel wire path 63 while being curved in the left-right direction. Thus, the wire 12 is more reliably restrained or prevented from coming off from the barrel wire path 63.

In the die grinder 100 of this embodiment, the recess 52 is formed in the inner peripheral surface of the tool housing 50 to receive the first and second wall parts 61, 62. With this structure, the unevenness of the outer surface of the barrel 60 due to the presence of the first and second wall parts 61, 62 is absorbed, so that the tool housing 50 can be formed into a smooth cylindrical shape. Further, the tool housing 50 is restricted from rotating relative to the barrel 60 by the first and second wall parts 61, 62 being received in the recess 52. Therefore, the tool housing 50 is easy to hold, so that the die grinder 100 is provided with high operability.

In the die grinder 100 of this embodiment, the motor wire path 306 for passing the wire 12 is provided between the support wall part 304 and the outer wall part 302 within the motor housing 30. The wire 12 led from the tool housing 50 is passed through the motor wire path 306 into the rear part of the housing HS, or the handle housing 40, while being restrained from coming into contact with elements disposed within the motor housing 30.

In the die grinder 100 of this embodiment, the barrel wire path 63, the opening 322 B and the motor wire path 306 are configured to communicate with each other. Increase in size of the motor housing 30 in the radial direction can be reduced or prevented, compared with a structure in which a wiring path of the wire is formed to bypass the motor bearing retainer 32. For example, downward protrusion of the outer shape of the motor housing 30 can be suppressed or reduced. Further, by utilizing the opening 322 formed as the vent hole in the motor bearing retainer 32, the wiring path of the wire 12 that connects the tool housing 50 and the motor housing 30 can be formed without changing the design of the motor bearing retainer 32.

In the die grinder 100 of this embodiment, the controller 10 is arranged such that the drive axis TX passes therethrough. This arrangement allows reduction in size of the housing HS in the radial direction.

In the die grinder 100 of this embodiment, the motor rotation axis MX is coincident with the drive axis TX. This arrangement allows reduction in size of the housing HS in the radial direction.

### B. OTHER EMBODIMENTS

(B1) In the die grinder 100 of the above-described first embodiment, in directions orthogonal to the drive axis TX, the direction DD1 toward the drive axis TX from the cross-sectional center HX of the grip part 42 is defined as the downward direction. The upward or downward direction may however be defined as described in (B1. 1) to (B1. 5) below.

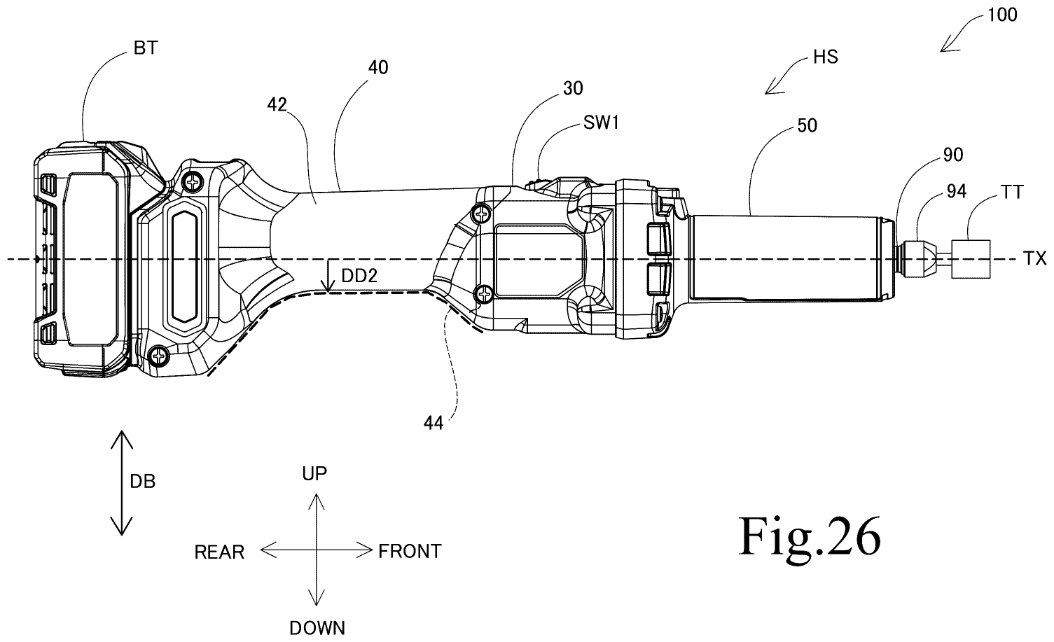

(B1. 1) As shown in FIG. 26, the mounting/removing direction DB of the battery BT on the battery mounting part 46 may be defined as the up-down direction. In this case, a direction DD2 toward the handle recess 44 from the cross-sectional center HX of the grip part 42 or the drive axis TX along the mounting/removing direction DB is defined as the downward direction.

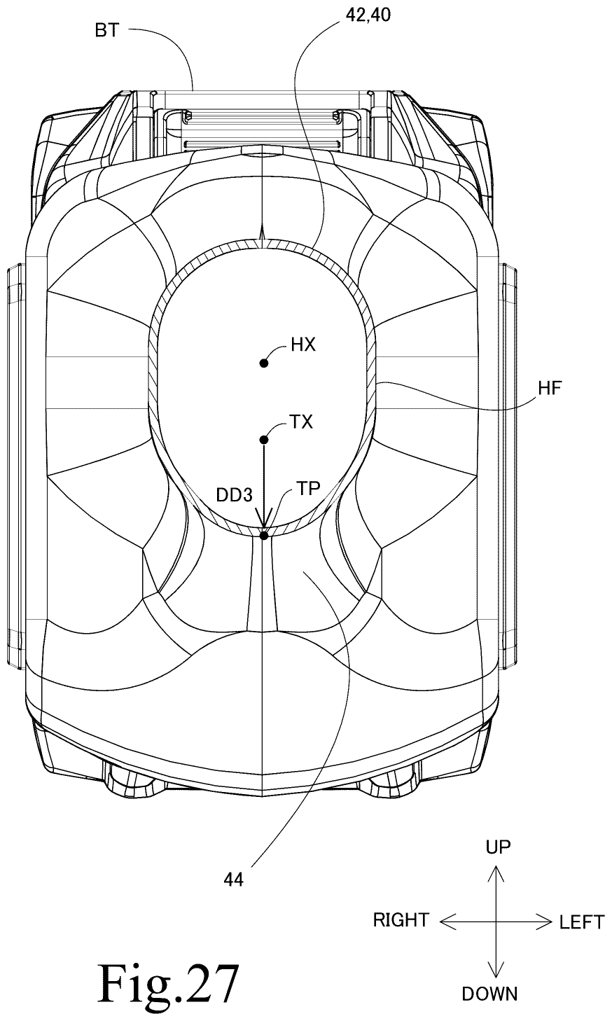

(B1. 2) In FIG. 27, the position of an end part TP having a maximum curvature on the outer contour HF of the grip part 42 in the cross section that is orthogonal to the drive axis is shown. A direction DD3 toward the end part TP from the drive axis TX may be defined as the downward direction. Alternatively, a direction toward the end part TP not from the drive axis TX but from the cross-sectional center HX of the grip part 42 may be defined as the downward direction. FIG. 27 shows a section taken at the same position as FIG. 3. By the arrangement that the end part TP having a maximum curvature is located on the lower side of the grip part 42, the grip part 42 is formed in a shape easy to hold.

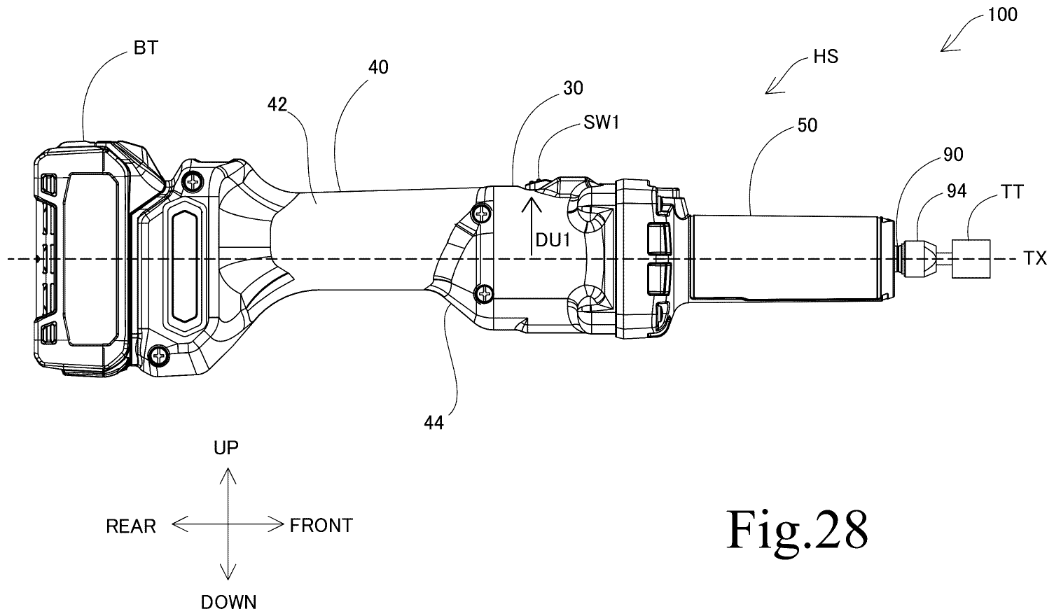

(B1. 3) As shown in FIG. 28, in directions orthogonal to the drive axis TX, a direction DUI toward the operation part SW1 from the drive axis TX may be defined as the upward direction. Alternatively, a direction toward the operation part SW1 not from the drive axis TX but from the cross-sectional center HX of the grip part 42 may be defined as the upward direction. By arrangement of the operation part SW1 on the upper side of the grip part 42, a user can easily operate the operation part SW1 while holding the grip part 42.

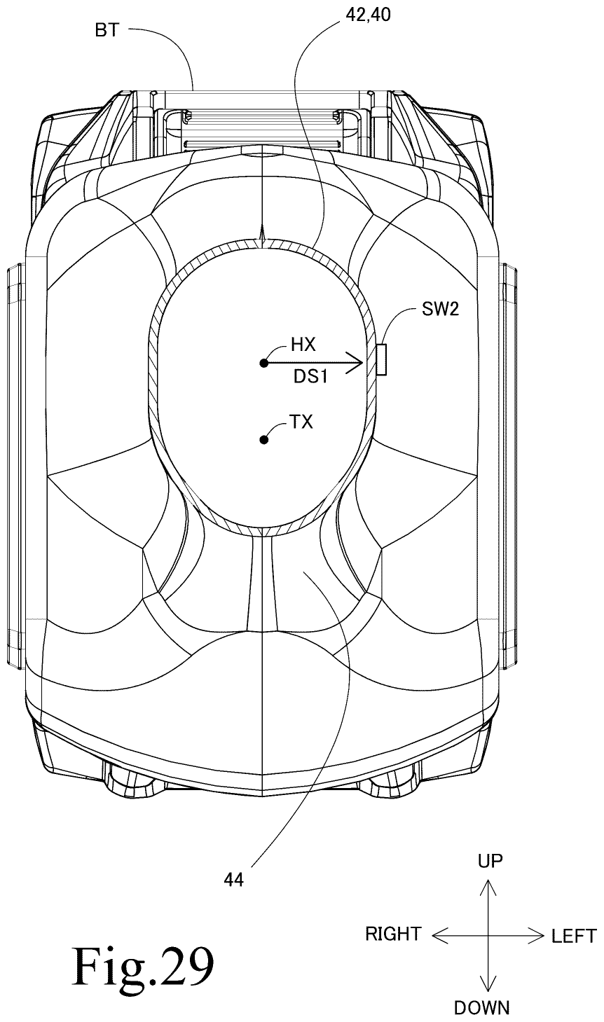

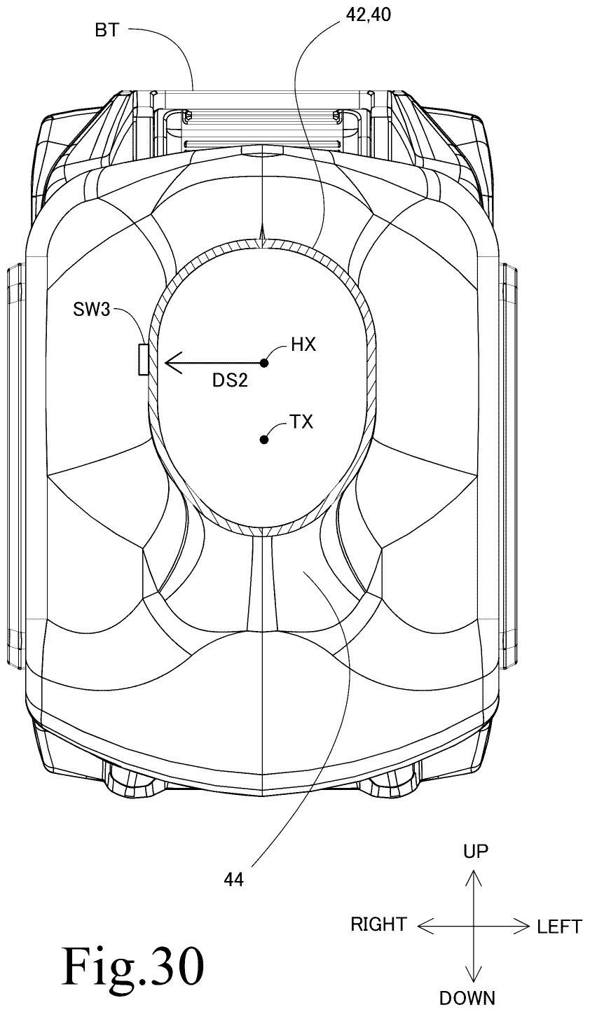

(B1. 4) As shown in FIGS. 29 and 30, in place of or in addition to the operation part SW1 shown in the above-described first embodiment, operation parts SW2, SW3 for on-off operation of the motor 20 may be provided on the lateral sides of the housing HS. By arrangement of the operation parts SW2, SW3 on the lateral sides, a user can easily operate the operation part SW2, SW3 while holding the grip part 42.

In this case, directions DS1, DS2 respectively toward the operation parts SW2, SW3 from the cross-sectional center HX of the grip part 42 may be defined as a rightward direction or a leftward direction. Alternatively, directions respectively toward the operation parts SW2, SW3 not from the cross-sectional center HX of the grip part 42 but from the drive axis TX may be defined as a rightward direction or a leftward direction.

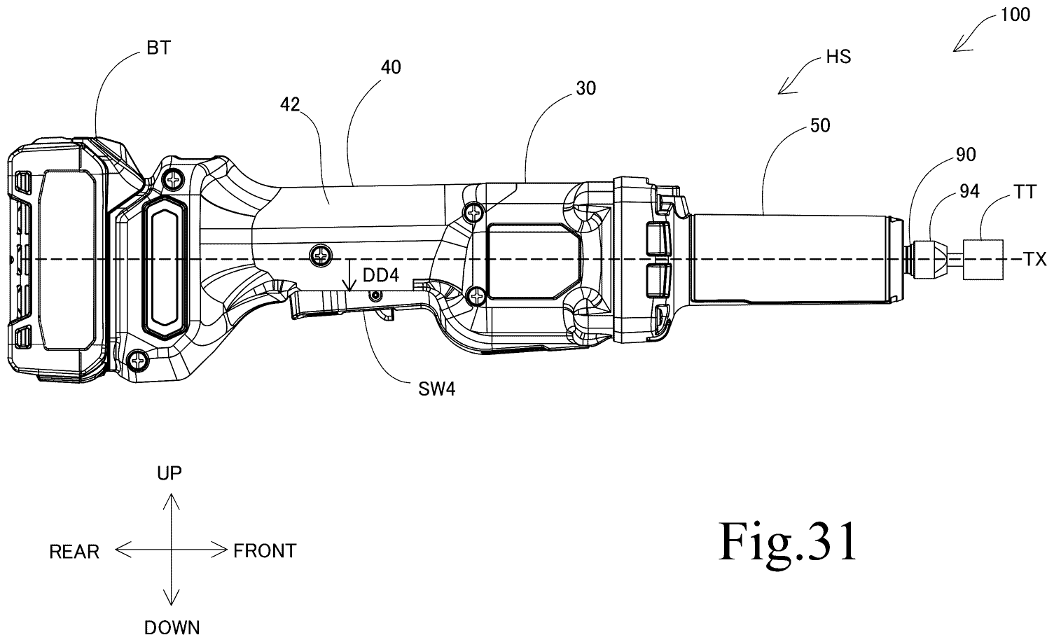

(B1. 5) As shown in FIG. 31, in place of or in addition to the operation part SW1 shown in the above-described first embodiment, a paddle switch SW4 may be provided on the housing HS. The motor 20 is turned on by sliding or pushing the paddle switch SW4, and turned off by releasing the operation of the paddle switch SW4. In this case, a direction DD4 toward the paddle switch SW4 from the drive axis TX may be defined as the downward direction. Alternatively, a direction toward the paddle switch SW4 not from the drive axis TX but from the cross-sectional center HX of the grip part 42 may be defined as the downward direction.

(B2) In the die grinder 100 of the above-described first embodiment, the light emitting parts 80 include the first light emitting part 81 arranged in the first quadrant Q1, the second light emitting part 82 arranged in the second quadrant Q2, and the third light emitting part 83 arranged right below the drive axis TX. The die grinder 100 may however have only the first and second light emitting parts 81, 82 respectively arranged in the first and second quadrants Q1, Q2 without having the third light emitting part 83. Even in this case, the irradiation range of light irradiated forward by the first and second light emitting parts 81, 82 arranged on the lateral sides of the drive axis TX can be wider, so that the visibility of the workpiece WS is improved.

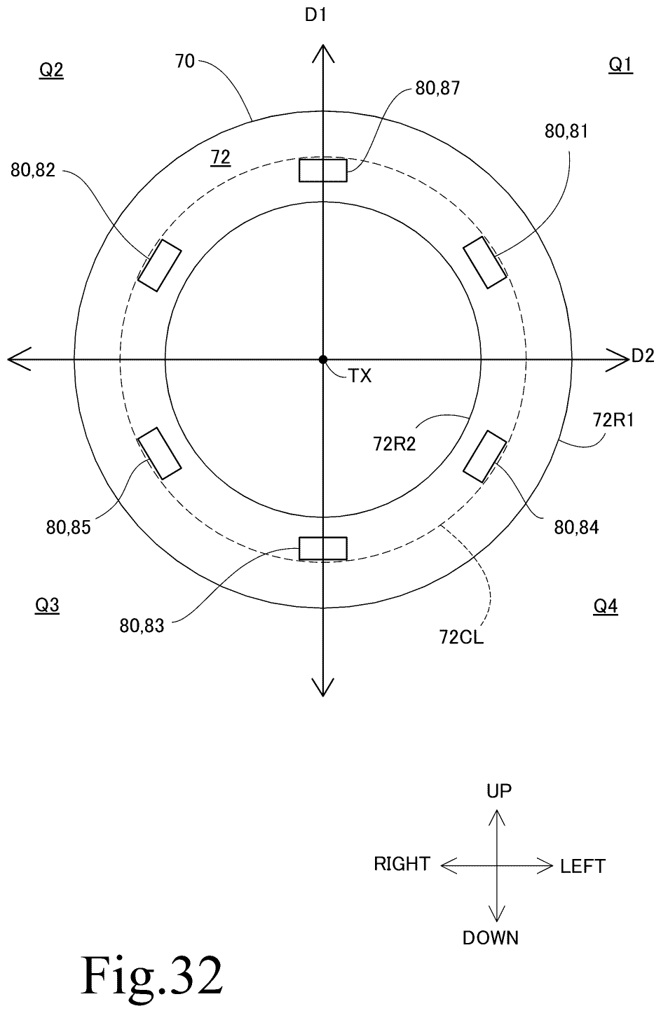

At least four light emitting parts 80 may be provided including the first and second light emitting parts 81, 82 respectively arranged in the first and second quadrants Q1, Q2. Illuminance of the workpiece WS is further improved by provision of the increased number of the light emitting parts 80. In an example shown in FIG. 32, six light emitting parts 80 are provided. Specifically, in addition to the first, second and third light emitting parts 81, 82, 83, fourth, fifth and sixth light emitting parts 84, 85, 87 are provided. In this case, the light emitting parts 80 are preferably arranged inside of the intermediate circle 72CL. With this arrangement, the irradiation range of each of the light emitting parts 80 is improved.

(B3) In the above-described embodiments, the battery mounting part 46 is provided on a rear end of the handle housing 40 and configured such that the battery BT is removably mounted thereto. In place of the battery mounting part 46, however, a power cord that can be connected to an AC power source such as an external commercial power source may be provided. In this case, power supplied from the commercial power source is supplied to the motor 20 via a wire and a connector arranged in the housing HS. The motor 20 is driven by the AC power. In this case, in place of the DC motor, an AC motor may be used as the motor 20.

(B4) In view of the nature of the present disclosure and the above-described embodiments, the following aspects are provided. The following aspects can be adopted in combination with the features of the die grinder 100 of the above-described embodiments, its modifications and the claimed invention.

(Aspect 1) A die grinder, comprising:
a motor that is driven by electric power;
a spindle that is rotationally driven by power of the motor around a drive axis that defines a front-rear direction of the die grinder;
a housing, including (i) a motor housing that houses the motor, (ii) a handle housing that is connected to a rear end of the motor housing and includes a grip part configured to be held by a user, and (iii) a tool housing in which the spindle and a circuit substrate are disposed; and
at least two light emitting parts that are assembled on a front surface of the circuit substrate;
wherein:
a part of the grip part that has a maximum curvature on an outer contour in a cross section that is orthogonal to the drive axis is defined as an end part, and a direction toward the end part from a cross-sectional center of the grip part or the drive axis is defined as a downward direction; and
when the front surface is divided into four quadrants by a line passing the drive axis in an up-down direction and a line passing the drive axis in a left-right direction orthogonal to the up-down direction,
the at least two light emitting parts include at least first and second light emitting parts that are respectively arranged in the upper right quadrant and the upper left quadrant of the four quadrants relative to the drive axis.

(Aspect 2) A die grinder, comprising:
a motor that is driven by electric power;
a spindle that is rotationally driven by power of the motor around a drive axis that defines a front-rear direction of the die grinder;
a housing, including (i) a motor housing that houses the motor, (ii) a handle housing that is connected to a rear end of the motor housing and includes a grip part configured to be held by a user, and (iii) a tool housing in which the spindle and a circuit substrate are disposed;
at least two light emitting parts that are assembled on a front surface of the circuit substrate; and
an operation part that is provided on the housing for on-off operation of the motor,
wherein:
in directions orthogonal to the drive axis, a direction toward the operation part from a cross-sectional center of the grip part or the drive axis is defined as an upward direction, and
when the front surface is divided into four quadrants by a line passing the drive axis in an up-down direction and a line passing the drive axis in a left-right direction orthogonal to the up-down direction,
the at least two light emitting parts include at least first and second light emitting parts that are respectively arranged in the upper right quadrant and the upper left quadrant of the four quadrants relative to the drive axis.

(Aspect 3) A die grinder, comprising:
a motor that is driven by electric power;
a spindle that is rotationally driven by power of the motor around a drive axis that defines a front-rear direction of the die grinder;
a housing, including (i) a motor housing that houses the motor, (ii) a handle housing that is connected to a rear end of the motor housing and includes a grip part configured to be held by a user, and (iii) a tool housing in which the spindle and a circuit substrate are disposed;
at least two light emitting parts that are assembled on a front surface of the circuit substrate; and
an operation part that is provided on the housing for on-off operation of the motor,
wherein:
in directions orthogonal to the drive axis, a direction toward the operation part from a cross-sectional center of the grip part or the drive axis is defined as a rightward or leftward direction, and
when the front surface is divided into four quadrants by a line passing the drive axis in an up-down direction orthogonal to a left-right direction and a line passing the drive axis in a left-right direction,
the at least two light emitting parts include at least first and second light emitting parts that are respectively arranged in the upper right quadrant and the upper left quadrant of the four quadrants relative to the drive axis.

The present disclosure is not limited to any of the above-described embodiments but may be implemented by a diversity of configurations without departing from the scope of the disclosure. For example, the technical features of any of the above embodiments may be replaced or combined appropriately, in order to solve part or all of the problems described above or in order to achieve part or all of the advantageous effects described above. Any of the technical features may be omitted appropriately unless the technical feature is described as essential in the description hereof.

### DESCRIPTION OF THE REFERENCE NUMERALS

10: controller, 12: wire, 14: switch, 16: connector, 20: motor, 21: motor body, 22: motor shaft, 26: fan, 30: motor housing, 32: motor bearing retainer, 40: handle housing, 42: grip part, 44: handle recess, 46: battery mounting part, 50: tool housing, 52: recess, 54: protrusion, 56: opening, 60: barrel, 60R: rib, 61: first wall part, 62: second wall part, 63: barrel wire path, 66: bearing retainer, 68: through hole, 70, 70R, 70R2: circuit substrate, 72: front surface, 72CL: intermediate circle, 72R1, 72R2: outer periphery, 80: light emitting part, 81, 81R, 81R2: first light emitting part, 82, 82R, 82R2: second light emitting part, 83, 83R, 83R2: third light emitting part, 84: fourth light emitting part, 85: fifth light emitting part, 86: protection member, 87: sixth light emitting part, 90: spindle, 92: collet cone, 94: collet nut, 100, 100R, 100R2: die grinder, 201: front motor bearing, 202: rear motor bearing, 204: coupling, 302: outer wall part, 304: support wall part, 304E: front end, 306: motor wire path, 322, 322B: opening, 601: front spindle bearing, 602: rear spindle bearing, 611: first protrusion, 622: second protrusion, 662: recess, 860: body part, 862: base part, 864: claw, BT: battery, DL: illumination device, HS: housing, HR1, HRR1, HRR3, HZ1, HZ3: horizontal plane, LR1, LR3, LRR1, LRR3: light, MX: motor rotation axis, SD: shade, SW1, SW2, SW3: operation part, SW4: paddle switch, TP: end part, TS: side face, TT: tool accessory, TX: drive axis, WS: workpiece

1. A die grinder, comprising:
a motor that is driven by electric power;
a spindle that is rotationally driven by power of the motor around a drive axis that defines a front-rear direction of the die grinder;
a housing, including (i) a motor housing that houses the motor, (ii) a handle housing that is connected to a rear end of the motor housing and includes a grip part configured to be held by a user, and (iii) a tool housing in which the spindle and a circuit substrate are disposed; and
at least two light emitting parts that are assembled on a front surface of the circuit substrate;
wherein:
in directions orthogonal to the drive axis, a direction toward the drive axis from a cross-sectional center of the grip part is defined as a downward direction, and
when the front surface is divided into four quadrants by a line passing the drive axis in an up-down direction and a line passing the drive axis in a left-right direction orthogonal to the up-down direction,
the at least two light emitting parts include at least first and second light emitting parts that are respectively arranged in the upper right quadrant and the upper left quadrant of the four quadrants relative to the drive axis.

2. A die grinder, comprising:
a motor that is driven by electric power supplied from a battery;
a spindle that is rotationally driven by power of the motor around a drive axis that defines a front-rear direction of the die grinder;
a housing, including (i) a motor housing that houses the motor, (ii) a handle housing that is connected to a rear end of the motor housing and includes a grip part configured to be held by a user, and (iii) a tool housing in which the spindle and a circuit substrate are disposed;
at least two light emitting parts that are assembled on a front surface of the circuit substrate; and
a battery mounting part that is configured such that the battery is removably mounted along a mounting/removing direction crossing the drive axis;
wherein:
the handle housing includes a handle recess that is formed by an outer surface of the handle housing being recessed relative to an outer surface of the motor housing, and
a direction toward the handle recess from the drive axis along the mounting/removing direction is defined as a downward direction, and
when the front surface is divided into four quadrants by a line passing the drive axis in an up-down direction and a line passing the drive axis in a left-right direction orthogonal to the up-down direction,
the at least two light emitting parts include at least first and second light emitting parts that are respectively arranged in the upper right quadrant and the upper left quadrant of the four quadrants relative to the drive axis.

3. A die grinder, comprising:
a motor that is driven by electric power;
a spindle that is rotationally driven by power of the motor around a drive axis that defines a front-rear direction of the die grinder;
a housing, including (i) a motor housing that houses the motor, (ii) a handle housing that is connected to a rear end of the motor housing and includes a grip part configured to be held by a user, and (iii) a tool housing in which the spindle and a circuit substrate are disposed;
at least two light emitting parts that are assembled on a front surface of the circuit substrate; and
a paddle switch that is provided on the grip part for on-off operation of the motor,
wherein:
in directions orthogonal to the drive axis, a direction toward the paddle switch from a cross-sectional center of the grip part is defined as a downward direction, and
when the front surface is divided into four quadrants by a line passing the drive axis in an up-down direction and a line passing the drive axis in a left-right direction orthogonal to the up-down direction,
the at least two light emitting parts include at least first and second light emitting parts that are respectively arranged in the upper right quadrant and the upper left quadrant of the four quadrants relative to the drive axis.

4. The die grinder as defined in claim 1, wherein the at least two light emitting parts further include a third light emitting part that is arranged right below the drive axis on the front surface.

5. The die grinder as defined in claim 1, wherein:
the front surface has an annular shape, and
the at least two light emitting parts are arranged on the front surface in a region inside of an intermediate circle, which is a circle formed along an intermediate position between two peripheries, which includes an outer periphery and an inner periphery closer to the drive axis.

6. The die grinder as defined in claim 1, further comprising:
a protection member that is provided in front of the at least two light emitting parts and transmits light of the at least two light emitting parts,
wherein:
the protection member has a body part that covers the at least two light emitting parts, a base part that extends rearward from the body part, and claws that are formed on an extending end of the base part and configured to be engaged with a recess that is formed in a member arranged rearward of the circuit substrate.

7. The die grinder as defined in claim 6, further comprising:
a spindle bearing that rotatably supports the spindle;
a barrel that houses the spindle bearing; and
a bearing retainer that is arranged in front of the spindle bearing and fixed to a front end part of the barrel;
wherein:
the recess is formed in an outer surface of the bearing retainer, and
the circuit substrate and the at least two light emitting parts are held between the protection member and the bearing retainer with the claws and the recess engaged with each other.

8. The die grinder as defined in claim 1, comprising:
a barrel that houses at least part of the spindle;
wherein:
the barrel has first and second wall parts protruding from an outer surface of the barrel, and
an electric wire connected to the circuit substrate is arranged in a barrel wire path that is defined by the first and second wall parts.

9. The die grinder as defined in claim 8, wherein:
a first protrusion is formed on a surface of the first wall part facing the second wall part and protrudes toward the second wall part, and
a second protrusion is formed on a surface of the second wall part facing the first wall part and protrudes toward the first wall part.

10. The die grinder as defined in claim 8, wherein a recess is formed in an inner surface of the tool housing to receive the first and second wall parts.

11. The die grinder as defined in claim 8, wherein:
the motor housing includes (i) an outer wall part and (ii) a support wall part that supports the motor within the motor housing, and
a motor wire path passing the wire is provided between the support wall part and the outer wall within the motor housing.

12. The die grinder as defined in claim 11, further comprising:
a fan cooling the motor;
a motor bearing that is disposed between the motor and the spindle within the housing and rotatably supports a motor shaft of the motor; and
a motor bearing retainer that supports the motor bearing,
wherein:
the motor bearing retainer has an opening through which air flow from the fan passes, and
the barrel wire path, the opening and the motor wire path are configured to communicate with each other.

13. The die grinder as defined in claim 1, further comprising:
a controller that controls operations of the die grinder,
wherein:
the controller is arranged such that the drive axis passes therethrough.

14. The die grinder as defined in claim 1, wherein:
the motor has a motor shaft that rotates around a motor rotation axis, and
the motor rotation axis is coincident with the drive axis.

15. The die grinder as defined in claim 1, further comprising:
a battery for supplying power to the motor; and
a battery mounting part configured such that the battery is removably mounted thereto.
